(19) United States
(12) Patent Application Publication
(10) Pub. No.: US 2024/0257276 A1
(43) Pub. Date: Aug. 1, 2024

(54) INTELLIGENT MANUFACTURING EXECUTION SYSTEM (MES) FOR BATTERY MANUFACTURING WITH AUTONOMOUS SYSTEMS

(71) Applicant: HONEYWELL INTERNATIONAL INC., Charlotte, NC (US)

(72) Inventors: Viraj Srivastava, Bengaluru (IN); Praveen Sam, Cypress, TX (US); Niranjan Amrutur Subba Rao, Bangalore (IN)

(21) Appl. No.: 18/420,783

(22) Filed: Jan. 24, 2024

(30) Foreign Application Priority Data
Jan. 27, 2023 (IN) 202311005595

(51) Int. Cl. G06Q 50/04; H01M 10/04

(52) U.S. Cl. CPC G06Q 50/04; H01M 10/04

(57) ABSTRACT

Example methods, apparatuses, systems, and computer program products are provided. For example, an example computer-implemented method includes receiving a battery manufacturing operation parameter indicator, determining whether the battery manufacturing operation parameter indicator satisfies a battery manufacturing parameter threshold indicator, and in response to determining that the battery manufacturing operation parameter indicator does not satisfy the battery manufacturing parameter threshold indicator, the example computer-implemented method comprises: generating a battery manufacturing deviation event data object, and generating a battery manufacturing adjustment data object based at least in part on inputting the battery manufacturing deviation event data object to one or more machine learning models.

### CROSS-REFERENCE TO RELATED APPLICATIONS

This application claims the benefit of priority of IN Patent Application No. 202311005595, titled “INTELLIGENT MANUFACTURING EXECUTION SYSTEM (MES) FOR BATTERY MANUFACTURING WITH AUTONOMOUS SYSTEMS”, filed on Jan. 27, 2023, which is herein incorporated by reference in its entirety.

### FIELD OF THE INVENTION

Example embodiments of the present disclosure relate generally to autonomous systems. For example, example embodiments of the present disclosure may be implemented in battery manufacturing such as, but not limited to, lithium battery manufacturing.

### BACKGROUND

Applicant has identified many technical challenges and difficulties associated with manufacturing devices, systems, and methods, including, but not limited to, manufacturing devices, systems, and methods for batteries such as, but not limited to, lithium batteries.

### BRIEF SUMMARY

Various embodiments described herein relate to methods, apparatuses, and systems for battery manufacturing are provided.

In accordance with various embodiments of the present disclosure, an example apparatus is provided. In some embodiments, the example apparatus comprises at least one processor and at least one non-transitory memory comprising a computer program code. In some embodiments, the at least one non-transitory memory and the computer program code are configured to, with the at least one processor, cause the apparatus to receive a battery manufacturing operation parameter indicator, wherein the battery manufacturing operation parameter indicator is associated with a battery manufacturing batch indicator and a battery manufacturing operation indicator. In some embodiments, the at least one non-transitory memory and the computer program code are configured to, with the at least one processor, cause the apparatus to determine whether the battery manufacturing operation parameter indicator satisfies a battery manufacturing parameter threshold indicator, wherein the battery manufacturing parameter threshold indicator is associated with the battery manufacturing operation indicator. In response to determining that the battery manufacturing operation parameter indicator does not satisfy the battery manufacturing parameter threshold indicator, in some embodiments, the at least one non-transitory memory and the computer program code are configured to, with the at least one processor, cause the apparatus to generate a battery manufacturing deviation event data object, wherein the battery manufacturing deviation event data object comprises the battery manufacturing operation parameter indicator and a plurality of additional battery manufacturing operation parameter indicators that is associated with the battery manufacturing batch indicator. Also, in some embodiments, the at least one non-transitory memory and the computer program code are configured to, with the at least one processor, cause the apparatus to generate a battery manufacturing adjustment data object based at least in part on inputting the battery manufacturing deviation event data object to one or more machine learning models.

In some embodiments, the plurality of additional battery manufacturing operation parameter indicators is associated with a plurality of additional battery manufacturing operation indicators. In some embodiments, the plurality of additional battery manufacturing operation indicators is different from the battery manufacturing operation indicator.

In some embodiments, the battery manufacturing adjustment data object comprises an adjusted battery manufacturing operation parameter indicator.

In some embodiments, the one or more machine learning models comprise a deviation event similarity determination machine learning model. In some embodiments, the at least one non-transitory memory and the computer program code are configured to, with the at least one processor, cause the apparatus to: receive, from a battery manufacturing deviation event repository, a plurality of historical battery manufacturing deviation event data objects. In some embodiments, the at least one non-transitory memory and the computer program code are configured to, with the at least one processor, cause the apparatus to input the battery manufacturing deviation event data object and the plurality of historical battery manufacturing deviation event data objects to the deviation event similarity determination machine learning model, and receive, from the deviation event similarity determination machine learning model, a plurality of deviation event similarity indicators.

In some embodiments, each of the plurality of deviation event similarity indicators indicates a corresponding deviation event similarity level between the battery manufacturing deviation event data object and one of the plurality of historical battery manufacturing deviation event data objects.

In some embodiments, a deviation event similarity indicator is associated with the battery manufacturing deviation event data object and a historical battery manufacturing deviation event data object from the plurality of historical battery manufacturing deviation event data objects. In some embodiments, the at least one non-transitory memory and the computer program code are configured to, with the at least one processor, cause the apparatus to: in response to determining that the deviation event similarity indicator satisfies a deviation event similarity threshold indicator: receive, from the battery manufacturing deviation event repository, a historical battery manufacturing adjustment data object corresponding to the historical battery manufacturing deviation event data object, and generate the battery manufacturing adjustment data object based at least in part on the historical battery manufacturing adjustment data object.

In some embodiments, the one or more machine learning models comprise a deviation event classification estimation machine learning model, wherein the at least one non-transitory memory and the computer program code are configured to, with the at least one processor, cause the apparatus to: in response to determining that the plurality of deviation event similarity indicators does not satisfy a deviation event similarity threshold indicator: input the battery manufacturing deviation event data object to the deviation event classification estimation machine learning model, and receive, from the deviation event classification estimation machine learning model, an estimated deviation event classification indicator associated with the battery manufacturing deviation event data object and a plurality of candidate battery manufacturing adjustment data objects.

In some embodiments, each of the plurality of candidate battery manufacturing adjustment data objects comprises at least one candidate adjusted battery manufacturing operation parameter indicator.

In some embodiments, the one or more machine learning models comprise a battery manufacturing outcome prediction machine learning model. In some embodiments, the at least one non-transitory memory and the computer program code are configured to, with the at least one processor, cause the apparatus to: input the plurality of candidate battery manufacturing adjustment data objects to the battery manufacturing outcome prediction machine learning model. In some embodiments, the at least one non-transitory memory and the computer program code are configured to, with the at least one processor, cause the apparatus to receive, from the battery manufacturing outcome prediction machine learning model, a plurality of predicted battery manufacturing outcome data objects associated with the plurality of candidate battery manufacturing adjustment data objects, and generate the battery manufacturing adjustment data object based at least in part on the plurality of candidate battery manufacturing adjustment data objects and the plurality of predicted battery manufacturing outcome data objects.

In some embodiments, the plurality of predicted battery manufacturing outcome data objects is associated with a plurality of predicted battery manufacturing outcome confidence-to-risk indicators.

In some embodiments, the at least one non-transitory memory and the computer program code are configured to, with the at least one processor, cause the apparatus to: select, from the plurality of predicted battery manufacturing outcome data objects, a predicted battery manufacturing outcome data object associated with a highest predicted battery manufacturing outcome confidence-to-risk indicator. In some embodiments, the at least one non-transitory memory and the computer program code are configured to, with the at least one processor, cause the apparatus to select, from the plurality of candidate battery manufacturing adjustment data objects, a candidate battery manufacturing adjustment data object associated with the predicted battery manufacturing outcome data object, and generate the battery manufacturing adjustment data object based at least in part on the candidate battery manufacturing adjustment data object.

In some embodiments, the at least one non-transitory memory and the computer program code are configured to, with the at least one processor, cause the apparatus to: determine whether a predicted battery manufacturing outcome confidence-to-risk indicator associated with a predicted battery manufacturing outcome data object satisfies the autonomous battery manufacturing adjustment threshold indicator.

In some embodiments, the at least one non-transitory memory and the computer program code are configured to, with the at least one processor, cause the apparatus to: in response to determining that the predicted battery manufacturing outcome confidence-to-risk indicator satisfies the autonomous battery manufacturing adjustment threshold indicator: select a candidate battery manufacturing adjustment data object corresponding to the predicted battery manufacturing outcome data object, and generate the battery manufacturing adjustment data object based on the candidate battery manufacturing adjustment data object.

In some embodiments, the at least one non-transitory memory and the computer program code are configured to, with the at least one processor, cause the apparatus to: in response to determining that the predicted battery manufacturing outcome confidence-to-risk indicator does not satisfy the autonomous battery manufacturing adjustment threshold indicator, determine whether the predicted battery manufacturing outcome confidence-to-risk indicator satisfies a supervised battery manufacturing adjustment threshold indicator.

In some embodiments, the at least one non-transitory memory and the computer program code are configured to, with the at least one processor, cause the apparatus to: in response to determining that the predicted battery manufacturing outcome confidence-to-risk indicator satisfies the supervised battery manufacturing adjustment threshold indicator: select a candidate battery manufacturing adjustment data object corresponding to the predicted battery manufacturing outcome data object. In some embodiments, the at least one non-transitory memory and the computer program code are configured to, with the at least one processor, cause the apparatus to generate the battery manufacturing adjustment data object based at least in part on the candidate battery manufacturing adjustment data object and a battery manufacturing supervision request associated with the battery manufacturing adjustment data object.

In some embodiments, the at least one non-transitory memory and the computer program code are configured to, with the at least one processor, cause the apparatus to: in response to determining that the predicted battery manufacturing outcome confidence-to-risk indicator does not satisfy the supervised battery manufacturing adjustment threshold indicator, generate a battery manufacturing manual adjustment request.

In accordance with various embodiments of the present disclosure, an example computer-implemented method is provided. In some embodiments, the computer-implemented method comprises receiving a battery manufacturing operation parameter indicator, wherein the battery manufacturing operation parameter indicator is associated with a battery manufacturing batch indicator and a battery manufacturing operation indicator. In some embodiments, the computer-implemented method comprises determining whether the battery manufacturing operation parameter indicator satisfies a battery manufacturing parameter threshold indicator, wherein the battery manufacturing parameter threshold indicator is associated with the battery manufacturing operation indicator. In response to determining that the battery manufacturing operation parameter indicator does not satisfy the battery manufacturing parameter threshold indicator, in some embodiments, the computer-implemented method comprises: generating a battery manufacturing deviation event data object, wherein the battery manufacturing deviation event data object comprises the battery manufacturing operation parameter indicator and a plurality of additional battery manufacturing operation parameter indicators that is associated with the battery manufacturing batch indicator, and generating a battery manufacturing adjustment data object based at least in part on inputting the battery manufacturing deviation event data object to one or more machine learning models.

In accordance with various embodiments of the present disclosure, an example computer program product is provided. In some embodiments, the computer program product comprises at least one non-transitory computer-readable storage medium having computer-readable program code portions stored therein. In some embodiments, the computer-readable program code portions comprise an executable portion configured to receive a battery manufacturing operation parameter indicator, wherein the battery manufacturing operation parameter indicator is associated with a battery manufacturing batch indicator and a battery manufacturing operation indicator. In some embodiments, the computer-readable program code portions comprise an executable portion configured to determine whether the battery manufacturing operation parameter indicator satisfies a battery manufacturing parameter threshold indicator, wherein the battery manufacturing parameter threshold indicator is associated with the battery manufacturing operation indicator. In response to determining that the battery manufacturing operation parameter indicator does not satisfy the battery manufacturing parameter threshold indicator, in some embodiments, the computer-readable program code portions comprise an executable portion configured to: generate a battery manufacturing deviation event data object, wherein the battery manufacturing deviation event data object comprises the battery manufacturing operation parameter indicator and a plurality of additional battery manufacturing operation parameter indicators that is associated with the battery manufacturing batch indicator, and generate a battery manufacturing adjustment data object based at least in part on inputting the battery manufacturing deviation event data object to one or more machine learning models.

The foregoing illustrative summary, as well as other exemplary objectives and/or advantages of the disclosure, and the manner in which the same are accomplished, are further explained in the following detailed description and its accompanying drawings.

### BRIEF DESCRIPTION OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1 is an example system architecture diagram illustrating an example intelligent battery manufacturing execution system (MES) in accordance with some embodiments of the present disclosure;

FIG. 2 illustrates an example block diagram of an example intelligent computing device in accordance with some embodiments of the present disclosure;

FIG. 3 illustrates an example machine learning model based battery manufacturing method that provides various technical improvements and advantages in accordance with some embodiments of the present disclosure;

FIG. 4 illustrates is an example block diagram illustrating various example battery manufacturing operations and example battery manufacturing processes in accordance with some embodiments of the present disclosure;

FIG. 5 illustrates example data communications between battery manufacturing operation devices and an example intelligent computing device in accordance with some embodiments of the present disclosure;

FIG. 6 illustrates an example machine learning model based battery manufacturing method that provides various technical improvements and advantages in accordance with some embodiments of the present disclosure;

FIG. 7A and FIG. 7B illustrate an example machine learning model based battery manufacturing method that provides various technical improvements and advantages in accordance with some embodiments of the present disclosure;

FIG. 8 illustrates an example machine learning model based battery manufacturing method that provides various technical improvements and advantages in accordance with some embodiments of the present disclosure;

FIG. 9 illustrates an example machine learning model based battery manufacturing method that provides various technical improvements and advantages in accordance with some embodiments of the present disclosure;

FIG. 10 illustrates an example machine learning model based battery manufacturing method that provides various technical improvements and advantages in accordance with some embodiments of the present disclosure;

FIG. 11 illustrates an example machine learning model based battery manufacturing method that provides various technical improvements and advantages in accordance with some embodiments of the present disclosure;

FIG. 12A and FIG. 12B illustrates an example machine learning model based battery manufacturing method that provides various technical improvements and advantages in accordance with some embodiments of the present disclosure; and

FIG. 13 illustrates an example machine learning model based battery manufacturing method that provides various technical improvements and advantages in accordance with some embodiments of the present disclosure.

### DETAILED DESCRIPTION OF THE INVENTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The term “electronically coupled,” “electronically coupling,” “electronically couple,” “in communication with,” “in electronic communication with,” or “connected” in the present disclosure refers to two or more elements or components being connected through wired means and/or wireless means, such that signals, electrical voltage/current, data and/or information may be transmitted to and/or received from these elements or components.

As described above, there are many technical challenges and difficulties associated with manufacturing devices, systems, and methods for batteries such as, but not limited to, lithium batteries. For example, many devices, systems, and methods fail to provide safety and reliability guarantee when managing battery manufacturing processes.

Various embodiments of the present disclosure overcome these technical challenges and difficulties, and provide various technical improvements and advantages. For example, various embodiments of the present disclosure implement one or more machine learning models that generate battery manufacturing adjustment data objects, which can improve the safety and reliability when manufacturing batteries such as, but not limited to, lithium batteries. As such various embodiments of the present disclosure enable precise execution of every step in the production process such that optimal conditions are set and deviations are autonomously corrected during production to ensure predictable quality. Various embodiments of the present disclosure enable low cost and low risk production of components such as lithium batteries without the risks of recalls due to low quality manufacturing.

In the present disclosure, the term “data object” refers to a data structure that represents one or more functionalities and/or characteristics associated with data and/or information (for example, but not limited to, data and/or information associated with battery manufacturing). In some embodiments, a data object may be generated by a combination of one or more software (for example, one or more computer programs) and/or one or more hardware (for example, one or more servers and/or one or more client devices). In some embodiments, a data object may provide a functional unit for one or more computer programs.

In the present disclosure, the term “indicator” refers to digital data that may describe or is associated with one or more attributes, one or more data fields associated with a system (such as, but not limited to, a battery manufacturing system as described herein).

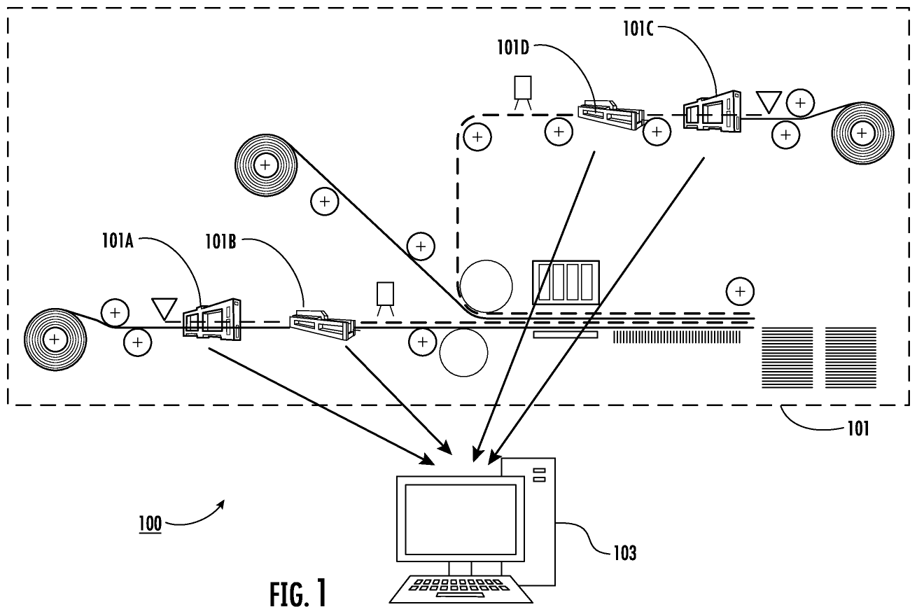

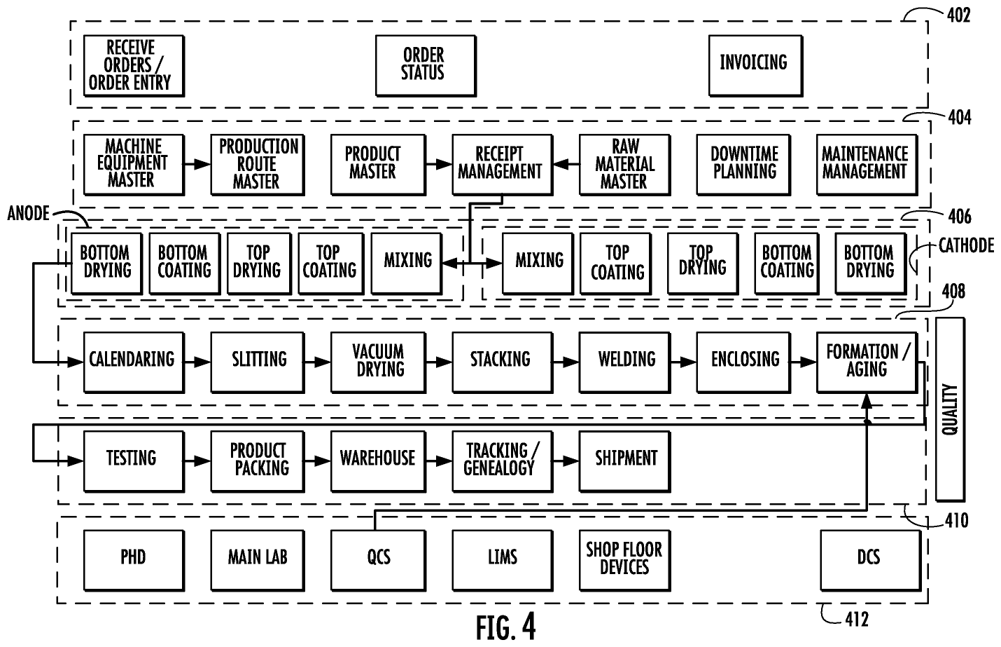

In the present disclosure, the term “battery manufacturing operation parameter indicator” refers to an indicator that represents, indicates, and/or comprises one or more battery manufacturing operation parameter values or variables associated with a battery manufacturing operation. For example, an example battery manufacturing operation parameter indicator may indicate a weight value associated with the anode coating, a thickness value associated with the anode coating, a weight value associated with the cathode coating, a thickness value associated with the cathode coating, and/or the like. Additional details associated with example battery manufacturing operation parameter indicators are described herein, including, but not limited to, in connection with at least FIG. 1 and FIG. 4. In some embodiments, the battery manufacturing operation parameter indicator may be in the form of text string(s), numerical character(s), alphabetical character(s), alphanumeric code(s), ASCII character(s), and/or the like.

In the present disclosure, the term “battery manufacturing batch indicator” refers to an indicator that represents, indicates, and/or comprises a batch value associated with battery manufacturing. For example, each batch of batteries that are manufactured by a battery manufacturing facility may be associated with an unique battery manufacturing batch indicator. In some embodiments, the battery manufacturing batch indicator may be in the form of text string(s), numerical character(s), alphabetical character(s), alphanumeric code(s), ASCII character(s), and/or the like.

In the present disclosure, the term “battery manufacturing operation indicator” refers to an indicator that represents, indicates, and/or comprises a battery manufacturing operation identifier and/or a battery manufacturing process identifier associated with battery manufacturing. In some embodiments, the battery manufacturing operation indicator may be in the form of text string(s), numerical character(s), alphabetical character(s), alphanumeric code(s), ASCII character(s), and/or the like. Example battery manufacturing operation indicators are described herein including, but not limited to, those described in connection with at least FIG. 4.

In the present disclosure, the term “battery manufacturing parameter threshold indicator” refers to an indicator that represents, indicates, and/or comprises a threshold value associated with a battery manufacturing operation parameter. For example, if the battery manufacturing operation parameter satisfies the battery manufacturing parameter threshold value, the battery manufacturing operation associated with the battery manufacturing operation parameter is normal. If the battery manufacturing operation parameter does not satisfy the battery manufacturing parameter threshold value, the battery manufacturing operation associated with the battery manufacturing operation parameter is not normal. In some embodiments, the battery manufacturing parameter threshold indicator may be in the form of text string(s), numerical character(s), alphabetical character(s), alphanumeric code(s), ASCII character(s), and/or the like.

In the present disclosure, the term “battery manufacturing deviation event data object” refers to a type of data object that comprises data and/or information associated with one or more abnormal battery manufacturing processes and/or one or more abnormal battery manufacturing operations. For example, various embodiments of the present disclosure may generate a battery manufacturing deviation event data object when a battery manufacturing operation parameter indicator does not satisfy the corresponding battery manufacturing parameter threshold indicator. Additional details associated with the battery manufacturing deviation event data object are described herein.

In the present disclosure, the term “battery manufacturing adjustment data object” refers to a type of data object that comprises data and/or information associated with one or more adjustments to one or more battery manufacturing processes and/or one or more battery manufacturing operations.

In some embodiments, an example computing device may generate a plurality of candidate battery manufacturing adjustment data objects, and select one of the plurality of candidate battery manufacturing adjustment data objects as the final battery manufacturing adjustment data object for adjusting one or more processes and/or one or more operations associated with battery manufacturing. Additional details associated with the candidate battery manufacturing adjustment data objects are described herein.

In some embodiments, an example battery manufacturing adjustment data object may comprise one or more adjusted battery manufacturing operation parameter indicators.

In the present disclosure, the term “adjusted battery manufacturing operation parameter indicator” refers to an indicator that represents, indicates, and/or comprises one or more battery manufacturing operation parameter values or variables that have been adjusted from the corresponding previous battery manufacturing operation parameter values or variables. In some embodiments, the adjusted battery manufacturing operation parameter indicator may be in the form of text string(s), numerical character(s), alphabetical character(s), alphanumeric code(s), ASCII character(s), and/or the like.

In some embodiments, an example computing device may generate a plurality of candidate adjusted battery manufacturing operation parameter indicators, and select one of the candidate adjusted battery manufacturing operation parameter indicators as the final adjusted battery manufacturing operation parameter indicator for the battery manufacturing facility. In some embodiments, each candidate adjusted battery manufacturing operation parameter indicator may be in the form of text string(s), numerical character(s), alphabetical character(s), alphanumeric code(s), ASCII character(s), and/or the like.

In the present disclosure, the term “historical battery manufacturing deviation event data object” refers to a type of data object that comprises data and/or information associated with one or more past or historical abnormal battery manufacturing processes and/or one or more past or historical abnormal battery manufacturing operations.

In the present disclosure, the term “historical battery manufacturing adjustment data object” refers to a type of data object that comprises data and/or information associated with one or more past or historical adjustments to one or more battery manufacturing processes and/or one or more battery manufacturing operations.

In the present disclosure, the term “battery manufacturing deviation event repository” refers to a database or a data repository that stores historical battery manufacturing deviation event data objects and/or historical battery manufacturing adjustment data objects associated with a battery manufacturing facility. For example, each of the plurality of historical battery manufacturing deviation event data objects is associated with one of the plurality of historical battery manufacturing adjustment data objects. In such an example, each historical battery manufacturing deviation event data object comprises data and/or information associated with a historical battery manufacturing deviation event (for example, when there were one or more abnormal battery manufacturing processes and/or one or more abnormal battery manufacturing operations), and the corresponding historical battery manufacturing adjustment data object comprises data and/or information associated with one or more adjustments to the one or more battery manufacturing processes and/or one or more battery manufacturing operations so that that battery manufacturing processes/operations become normal again.

In the present disclosure, the term “deviation event similarity determination machine learning model” refers to a machine learning model that is trained to generate one or more deviation event similarity indicators as one or more outputs in response to receiving a battery manufacturing deviation event data object with one or more historical battery manufacturing deviation event data objects.

In the present disclosure, the term “deviation event similarity indicator” refers to an indicator that represents, indicates, and/or comprises a deviation event similarity level between a battery manufacturing deviation event data object and a historical battery manufacturing deviation event data object. In some embodiments, the deviation event similarity indicator may be in the form of text string(s), numerical character(s), alphabetical character(s), alphanumeric code(s), ASCII character(s), and/or the like.

For example, an example deviation event similarity determination machine learning model may comprise supervised machine learning algorithms. Examples of supervised machine learning algorithms may include, but are not limited to, classification models (such as, but not limited to, decision tree, random forest, and/or the like), regression models (such as, but not limited to, linear regression, logistic regression), and/or the like. In such an example, the deviation event similarity determination machine learning model may be trained under supervision by using one or more labeled datasets that comprise one or more battery manufacturing deviation event data objects along with one or more historical battery manufacturing deviation event data objects and their corresponding known deviation event similarity indicators. During supervised training, the example deviation event similarity determination machine learning model may a receive battery manufacturing deviation event data object along with one or more historical battery manufacturing deviation event data objects from the one or more labeled datasets as inputs, and may adjust one or more parameters of its machine learning algorithms such that the deviation event similarity indicators from the example deviation event similarity determination machine learning model match the deviation event similarity indicators in the one or more labeled datasets.

As another example, an example deviation event similarity determination machine learning model may comprise unsupervised machine learning algorithms. Examples of unsupervised machine learning algorithms may include, but are not limited to, clustering models (such as, but not limited to, K-means clustering, hierarchical clustering, and/or the like), association models (such as, but not limited to, Apriori algorithm), and/or the like. In such an example, the deviation event similarity determination machine learning model may be trained by receiving a battery manufacturing deviation event data objects along with one or more historical battery manufacturing deviation event data objects as an unlabeled dataset and identifying one or more patterns from the battery manufacturing deviation event data object with the one or more historical battery manufacturing deviation event data objects to generate one or more deviation event similarity indicators as the outputs.

While the description above provides examples of deviation event similarity determination machine learning model, it is noted that the scope of the present disclosure is not limited to the description above. In some examples, an example deviation event similarity determination machine learning model may comprise one or more additional and/or alternative machine learning models. For example, an example deviation event similarity determination machine learning model may additionally or alternatively comprise support vector machine models, naive bayes models, artificial neural networks, and/or the like.

In the present disclosure, the term “deviation event similarity threshold indicator” refers to an indicator that represents, indicates, and/or comprises a deviation event similarity threshold between a battery manufacturing deviation event data object and a historical battery manufacturing deviation event data object. For example, if the deviation event similarity level between a battery manufacturing deviation event data object and a historical battery manufacturing deviation event data object does not satisfy the deviation event similarity threshold indicated by the deviation event similarity threshold indicator, the battery manufacturing deviation event data object and the historical battery manufacturing deviation event data object are not similar. If the deviation event similarity level between a battery manufacturing deviation event data object and a historical battery manufacturing deviation event data object satisfies the deviation event similarity threshold indicated by the deviation event similarity threshold indicator, the battery manufacturing deviation event data object and the historical battery manufacturing deviation event data object are similar. In some embodiments, the deviation event similarity threshold indicator may be in the form of text string(s), numerical character(s), alphabetical character(s), alphanumeric code(s), ASCII character(s), and/or the like.

In the present disclosure, the term “deviation event classification estimation machine learning model” refers to a type of machine learning model that is trained to generate one or more estimated deviation event classification indicators as one or more outputs in response to receiving one or more battery manufacturing deviation event data objects as one or more inputs.

In the present disclosure, the term “estimated deviation event classification indicator” refers to an indicator that represents, indicates, and/or comprises an estimated deviation event classification associated with the battery manufacturing deviation event data object. For example, the estimated deviation event classification indicator may indicate that the battery manufacturing deviation event data object is associated with one or more of the battery manufacturing processes and/or one or more battery manufacturing operations. In some embodiments, the estimated deviation event classification indicator may be in the form of text string(s), numerical character(s), alphabetical character(s), alphanumeric code(s), ASCII character(s), and/or the like.

For example, an example deviation event classification estimation machine learning model may comprise supervised machine learning algorithms. Examples of supervised machine learning algorithms may include, but are not limited to, classification models (such as, but not limited to, decision tree, random forest, and/or the like), regression models (such as, but not limited to, linear regression, logistic regression), and/or the like. In such an example, the deviation event classification estimation machine learning model may be trained under supervision by using one or more labeled datasets that comprise one or more battery manufacturing deviation event data objects and their corresponding known estimated deviation event classification indicators. During supervised training, the example deviation event classification estimation machine learning model may receive battery manufacturing deviation event data objects from the one or more labeled datasets as inputs, and may adjust one or more parameters of its machine learning algorithms such that the estimated deviation event classification indicators from the example deviation event classification estimation machine learning model match the estimated deviation event classification indicators in the one or more labeled datasets.

As another example, an example deviation event classification estimation machine learning model may comprise unsupervised machine learning algorithms. Examples of unsupervised machine learning algorithms may include, but are not limited to, clustering models (such as, but not limited to, K-means clustering, hierarchical clustering, and/or the like), association models (such as, but not limited to, Apriori algorithm), and/or the like. In such an example, the deviation event classification estimation machine learning model may be trained by receiving one or more battery manufacturing deviation event data objects as an unlabeled dataset and identifying one or more patterns from the one or more battery manufacturing deviation event data objects to generate one or more estimated deviation event classification indicators as the outputs.

While the description above provides examples of deviation event classification estimation machine learning model, it is noted that the scope of the present disclosure is not limited to the description above. In some examples, an example deviation event classification estimation machine learning model may comprise one or more additional and/or alternative machine learning models. For example, an example deviation event classification estimation machine learning model may additionally or alternatively comprise support vector machine models, naive bayes models, artificial neural networks, and/or the like.

In some embodiments, an example deviation event classification estimation machine learning model may also be trained to generate one or more candidate battery manufacturing adjustment data objects based on one or more estimated deviation event classification indicators.

For example, the deviation event classification estimation machine learning model may be trained under supervision by using one or more labeled datasets that comprise one or more estimated deviation event classification indicators and their corresponding known candidate battery manufacturing adjustment data objects. During supervised training, the example deviation event classification estimation machine learning model may receive estimated deviation event classification indicators from the one or more labeled datasets as inputs, and may adjust one or more parameters of its machine learning algorithms such that the candidate battery manufacturing adjustment data objects from the example deviation event classification estimation machine learning model match the candidate battery manufacturing adjustment data objects in the one or more labeled datasets.

In the present disclosure, the term “battery manufacturing outcome prediction machine learning model” refers to a type of machine learning model that has been trained to generate one or more predicted battery manufacturing outcome data objects as one or more outputs in response to receiving one or more candidate battery manufacturing adjustment data objects.

For example, an example battery manufacturing outcome prediction machine learning model may comprise supervised machine learning algorithms. Examples of supervised machine learning algorithms may include, but are not limited to, classification models (such as, but not limited to, decision tree, random forest, and/or the like), regression models (such as, but not limited to, linear regression, logistic regression), and/or the like. In such an example, the battery manufacturing outcome prediction machine learning model may be trained under supervision by using one or more labeled datasets that comprise one or more candidate battery manufacturing adjustment data objects and their corresponding known predicted battery manufacturing outcome data objects. During supervised training, the example battery manufacturing outcome prediction machine learning model may receive candidate battery manufacturing adjustment data objects from the one or more labeled datasets as inputs, and may adjust one or more parameters of its machine learning algorithms such that the predicted battery manufacturing outcome data objects from the example battery manufacturing outcome prediction machine learning model match the predicted battery manufacturing outcome data objects in the one or more labeled datasets.

As another example, an example battery manufacturing outcome prediction machine learning model may comprise unsupervised machine learning algorithms. Examples of unsupervised machine learning algorithms may include, but are not limited to, clustering models (such as, but not limited to, K-means clustering, hierarchical clustering, and/or the like), association models (such as, but not limited to, Apriori algorithm), and/or the like. In such an example, the battery manufacturing outcome prediction machine learning model may be trained by receiving one or more candidate battery manufacturing adjustment data objects as an unlabeled dataset and identifying one or more patterns from the one or more candidate battery manufacturing adjustment data objects to generate one or more predicted battery manufacturing outcome data objects as the outputs.

While the description above provides examples of battery manufacturing outcome prediction machine learning model, it is noted that the scope of the present disclosure is not limited to the description above. In some examples, an example battery manufacturing outcome prediction machine learning model may comprise one or more additional and/or alternative machine learning models. For example, an example battery manufacturing outcome prediction machine learning model may additionally or alternatively comprise support vector machine models, naive bayes models, artificial neural networks, and/or the like.

In the present disclosure, the term “predicted battery manufacturing outcome data object” refers to a type of data object that comprises data and/or information associated with simulated outcomes after one or more adjustments described in a candidate battery manufacturing adjustment data object are implemented in the battery manufacturing facility.

For example, the predicted battery manufacturing outcome data object may indicate that a safety level associated with the battery manufacturing in the battery manufacturing facility improves after implementing the one or more adjustments described in a candidate battery manufacturing adjustment data object, or may indicate that a safety level associated with the battery manufacturing in the battery manufacturing facility decreases after implementing the one or more adjustments described in a candidate battery manufacturing adjustment data object.

As another example, the predicted battery manufacturing outcome data object may indicate that the abnormal battery manufacturing processes or the abnormal battery manufacturing operations associated with the battery manufacturing in the battery manufacturing facility are resolved after implementing the one or more adjustments described in a candidate battery manufacturing adjustment data object, or may indicate that the abnormal battery manufacturing processes or the abnormal battery manufacturing operations associated with the battery manufacturing in the battery manufacturing facility are not resolved after implementing the one or more adjustments described in a candidate battery manufacturing adjustment data object.

In some embodiments, an example predicted battery manufacturing outcome data object comprises or is associated with a predicted battery manufacturing outcome confidence-to-risk indicator. In the present disclosure, the term “predicted battery manufacturing outcome confidence-to-risk indicator” refers to an indicator that represents, indicates, and/or comprises a ratio value between a confidence value and a risk value associated with a predicted battery manufacturing outcome data object.

In some embodiments, the confidence value associated with a predicted battery manufacturing outcome data object indicates a likelihood that one or more existing abnormal battery manufacturing processes or existing abnormal battery manufacturing operations associated with the battery manufacturing in the battery manufacturing facility will be resolved after implementing the one or more adjustments described in a candidate battery manufacturing adjustment data object.

In some embodiments, the risk value associated with a predicted battery manufacturing outcome data object indicates a likelihood that new or additional abnormal battery manufacturing operations or abnormal battery manufacturing operations associated with the battery manufacturing in the battery manufacturing facility may be triggered or caused by implementing the one or more adjustments described in a candidate battery manufacturing adjustment data object.

In some embodiments, the predicted battery manufacturing outcome confidence-to-risk indicator may be in the form of text string(s), numerical character(s), alphabetical character(s), alphanumeric code(s), ASCII character(s), and/or the like.

In the present disclosure, the term “autonomous battery manufacturing adjustment threshold indicator” refers to an indicator that represents, indicates, and/or comprises a threshold value associated with a predicted battery manufacturing outcome confidence-to-risk indicator for autonomously adjusting one or more battery manufacturing operation parameter indicators based on a battery manufacturing adjustment data object. For example, if the predicted battery manufacturing outcome confidence-to-risk indicator associated with a predicted battery manufacturing outcome data object satisfies the autonomous battery manufacturing adjustment threshold indicator, the battery manufacturing adjustment data object corresponding to the predicted battery manufacturing outcome data object may be implemented without manual user intervention or user supervision. If the predicted battery manufacturing outcome confidence-to-risk indicator associated with a predicted battery manufacturing outcome data object does not satisfy the autonomous battery manufacturing adjustment threshold indicator, the battery manufacturing adjustment data object corresponding to the predicted battery manufacturing outcome data object may be implemented with manual user intervention and/or with user supervision. In some embodiments, the autonomous battery manufacturing adjustment threshold indicator may be in the form of text string(s), numerical character(s), alphabetical character(s), alphanumeric code(s), ASCII character(s), and/or the like.

In the present disclosure, the term “supervised battery manufacturing adjustment threshold indicator” refers to an indicator that represents, indicates, and/or comprises a threshold value associated with a predicted battery manufacturing outcome confidence-to-risk indicator for adjusting one or more battery manufacturing operation parameter indicators based on a battery manufacturing adjustment data object under user supervision. For example, if the predicted battery manufacturing outcome confidence-to-risk indicator associated with a predicted battery manufacturing outcome data object satisfies the supervised battery manufacturing adjustment threshold indicator, the battery manufacturing adjustment data object corresponding to the predicted battery manufacturing outcome data object may be implemented with user supervision. If the predicted battery manufacturing outcome confidence-to-risk indicator associated with a predicted battery manufacturing outcome data object does not satisfy the supervised battery manufacturing adjustment threshold indicator, the battery manufacturing adjustment data object corresponding to the predicted battery manufacturing outcome data object cannot be implemented. In some embodiments, the autonomous battery manufacturing adjustment threshold indicator may be in the form of text string(s), numerical character(s), alphabetical character(s), alphanumeric code(s), ASCII character(s), and/or the like. In some embodiments, the supervised battery manufacturing adjustment threshold indicator may be in the form of text string(s), numerical character(s), alphabetical character(s), alphanumeric code(s), ASCII character(s), and/or the like.

In the present disclosure, the term “battery manufacturing supervision request” refers to an electronic request to an operator to supervise one or more adjustments to the one or more battery manufacturing operation parameter indicators based on the battery manufacturing adjustment data object.

In the present disclosure, the term “battery manufacturing manual adjustment request” refers to an electronic request to an operator to manually adjust the one or more battery manufacturing operation parameter indicators without any battery manufacturing adjustment data object.

Referring now to FIG. 1, an example system architecture diagram illustrates an example intelligent battery manufacturing execution system (MES) 100 in accordance with some embodiments of the present disclosure. In the example shown in FIG. 1, the example intelligent battery MES 100 comprises a plurality of battery manufacturing operation devices 101 and an intelligent computing device 103.

In some embodiments, each of the plurality of battery manufacturing operation devices 101 carries out and/or is associated with one or more battery manufacturing processes and/or one or more battery manufacturing operations in a battery manufacturing facility. For example, the plurality of battery manufacturing operation devices 101 may comprise one or more conveyors, one or more measurement devices, one or more cameras and/or the like.

For example, the plurality of battery manufacturing operation devices 101 may comprise a coating weight measurement device 101A that measures the weight associated with the anode coating, and may generate a battery manufacturing operation parameter indicator that indicates the weight associated with the anode coating.

As another example, the plurality of battery manufacturing operation devices 101 may comprise a coating thickness measurement device 101B that measures the thickness associated with the anode coating, and may generate a battery manufacturing operation parameter indicator that indicates the thickness associated with the anode coating.

As another example, the plurality of battery manufacturing operation devices 101 may comprise a coating weight measurement device 101C that measures the weight associated with the cathode coating, and may generate a battery manufacturing operation parameter indicator that indicates the weight associated with the cathode coating.

As another example, the plurality of battery manufacturing operation devices 101 may comprise a coating thickness measurement device 101D that measures the thickness associated with the cathode coating, and may generate a battery manufacturing operation parameter indicator that indicates the thickness associated with the cathode coating.

Additionally, or alternatively, the plurality of battery manufacturing operation devices 101 may comprise one or more additional and/or alternative devices.

In some embodiments, the plurality of battery manufacturing operation devices 101 are in data communications with the intelligent computing device 103, and may provide data and/or information associated with the battery manufacturing. For example, the plurality of battery manufacturing operation devices 101 may provide battery manufacturing operation parameter indicators to the intelligent computing device 103.

In some embodiments, the intelligent computing device 103 may be a computing device as described herein, including, but not limited to, desktop computers, laptop computers, smartphones, netbooks, tablet computers, wearables, and the like.

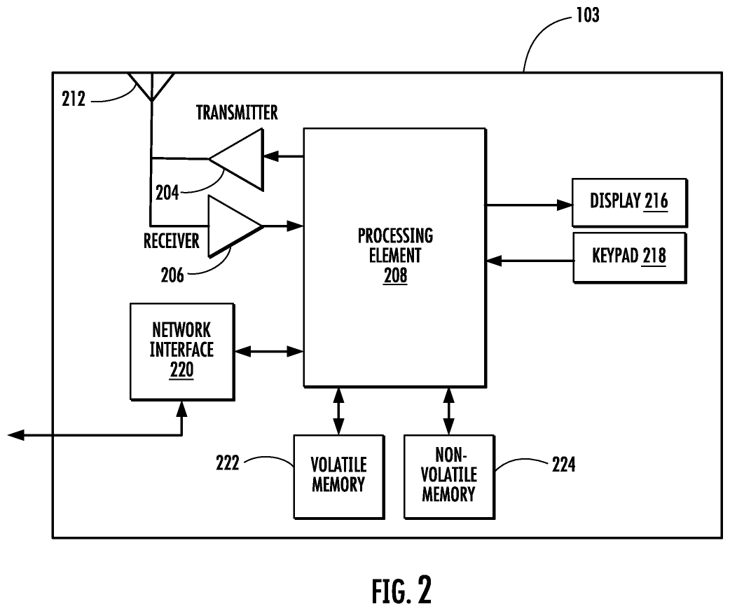

Referring now to FIG. 2, an example block diagram of an example intelligent computing device 103 in accordance with some embodiments of the present disclosure is illustrated.

For example, the example intelligent computing device 103 can include an antenna 212, a transmitter 204 (e.g., radio), a receiver 206 (e.g., radio), and a processing element 208 that provides signals to and receives signals from the transmitter 204 and receiver 206, respectively. The signals provided to and received from the transmitter 204 and the receiver 206, respectively, may include signaling information/data in accordance with an air interface standard of applicable wireless systems to communicate with various entities, such as another example intelligent computing device 103, and/or the like. In this regard, the example intelligent computing device 103 may be capable of operating with one or more air interface standards, communication protocols, modulation types, and access types. More particularly, the example intelligent computing device 103 may comprise a network interface 220, and may operate in accordance with any of a number of wireless communication standards and protocols. In a particular embodiment, the example intelligent computing device 103 may operate in accordance with multiple wireless communication standards and protocols, such as GPRS, UMTS, CDMA1900, 1×RTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the example intelligent computing device 103 can communicate with various other entities using Unstructured Supplementary Service data (USSD), Short Message Service (SMS), Multimedia Messaging Service (MMS), Dual-Tone Multi-Frequency (DTMF) Signaling, Subscriber Identity Module Dialer (SIM dialer), and/or the like. The example intelligent computing device 103 can also download changes, add-ons, and updates, for instance, to its firmware, software (e.g., including executable instructions, applications, program modules), and operating system.

According to one embodiment, the example intelligent computing device 103 may include location determining aspects, devices, modules, functionalities, and/or similar words used herein interchangeably. For example, the example intelligent computing device 103 may include outdoor positioning aspects, such as a location module adapted to acquire, for example, latitude, longitude, altitude, geocode, course, direction, heading, speed, UTC, date, and/or various other information/data. In one embodiment, the location module can acquire data, sometimes known as ephemeris data, by identifying the number of satellites in view and the relative positions of those satellites. The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. Alternatively, the location information/data/data may be determined by triangulating the position in connection with a variety of other systems, including cellular towers, Wi-Fi access points, and/or the like. Similarly, the example intelligent computing device 103 may include indoor positioning aspects, such as a location module adapted to acquire, for example, latitude, longitude, altitude, geocode, course, direction, heading, speed, time, date, and/or various other information/data. Some of the indoor aspects may use various position or location technologies including Radio-Frequency Identification (RFID) tags, indoor beacons or transmitters, Wi-Fi access points, cellular towers, nearby computing devices (e.g., smartphones, laptops) and/or the like. For instance, such technologies may include iBeacons, Gimbal proximity beacons, Bluetooth Low Energy (BLE) transmitters, Near Field Communication (NFC) transmitters, and/or the like. These indoor positioning aspects can be used in a variety of settings to determine the location of someone or something to within inches or centimeters.

The example intelligent computing device 103 may also comprise a user interface comprising one or more user input/output interfaces (e.g., a display 216 and/or speaker/speaker driver coupled to a processing element 208 and a touch screen, keyboard, mouse, and/or microphone coupled to a processing element 208). For example, the user output interface may be configured to provide an application, browser, user interface, dashboard, webpage, and/or similar words used herein interchangeably executing on and/or accessible via the example intelligent computing device 103 to cause display or audible presentation of information/data and for user interaction therewith via one or more user input interfaces. The user input interface can comprise any of a number of devices allowing the example intelligent computing device 103 to receive data, such as a keypad 218 (hard or soft), a touch display, voice/speech or motion interfaces, scanners, readers, or other input device. In embodiments including a keypad 218, the keypad 218 can include (or cause display of) the conventional numeric (0-9) and related keys (#, *), and other keys used for operating the example intelligent computing device 103 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the example intelligent computing device 103 can collect information/data, user interaction/input, and/or the like.

The example intelligent computing device 103 can also include volatile storage or memory 222 and/or non-volatile storage or memory 224, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the plurality of battery manufacturing operation devices 101.

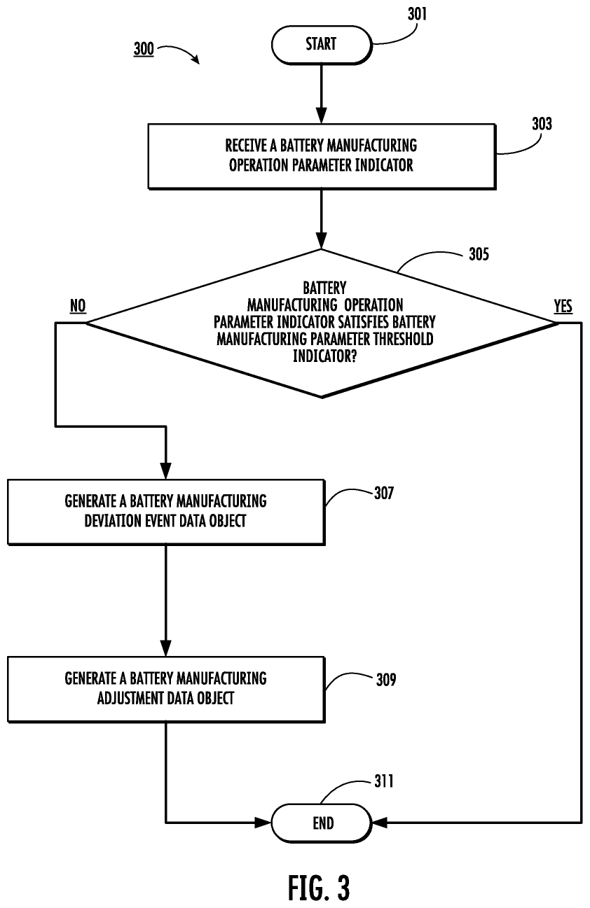

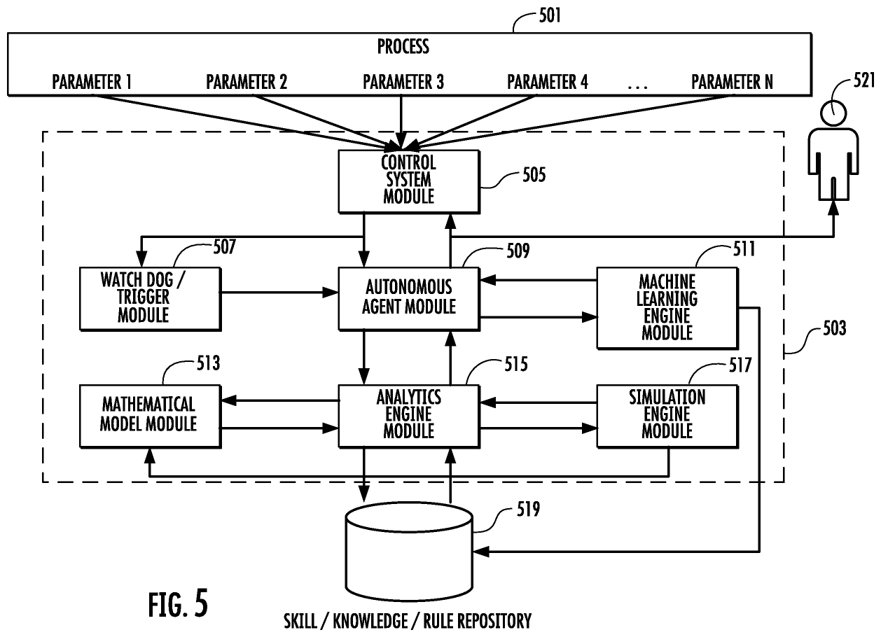

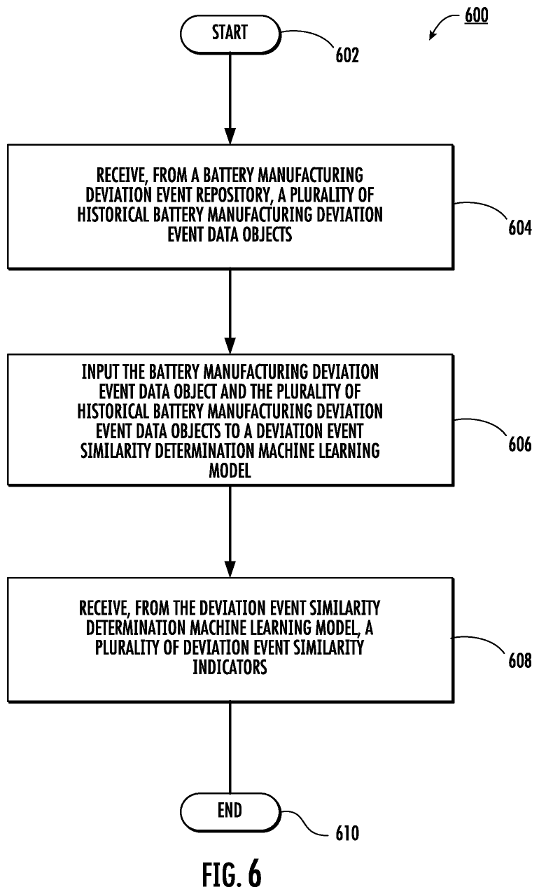

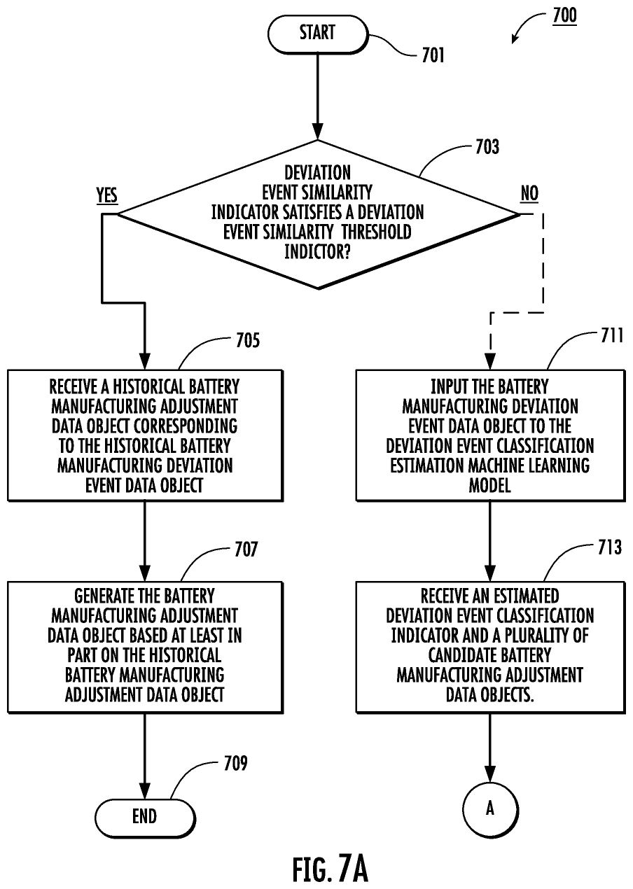

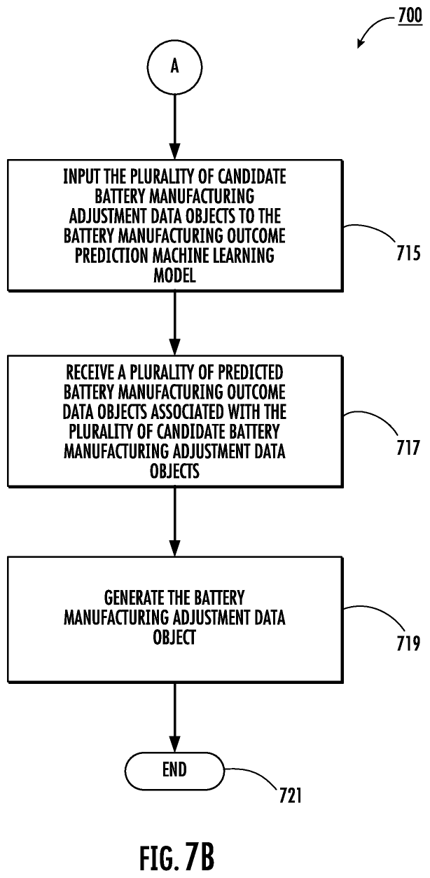

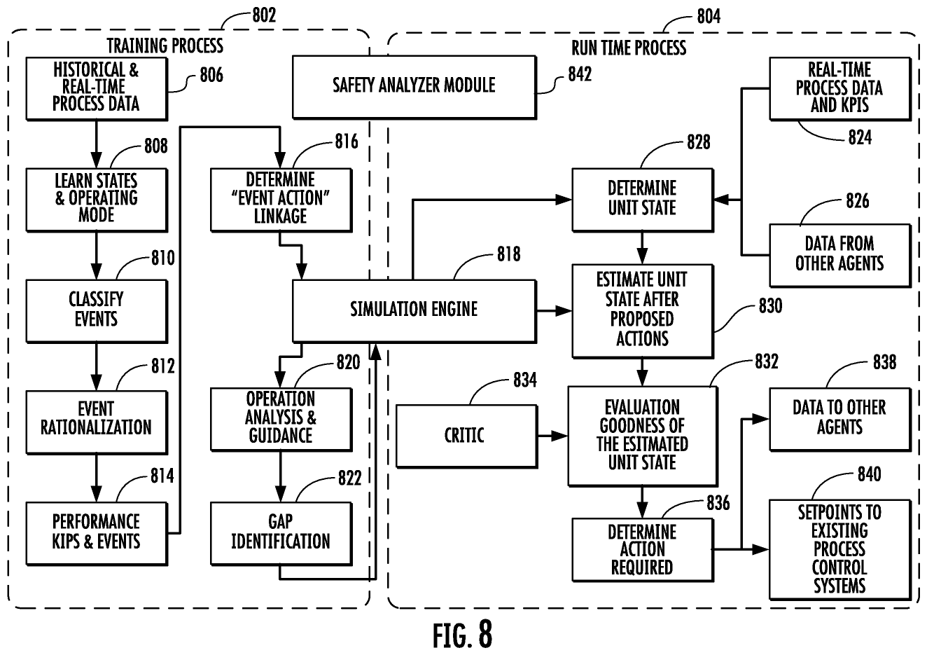

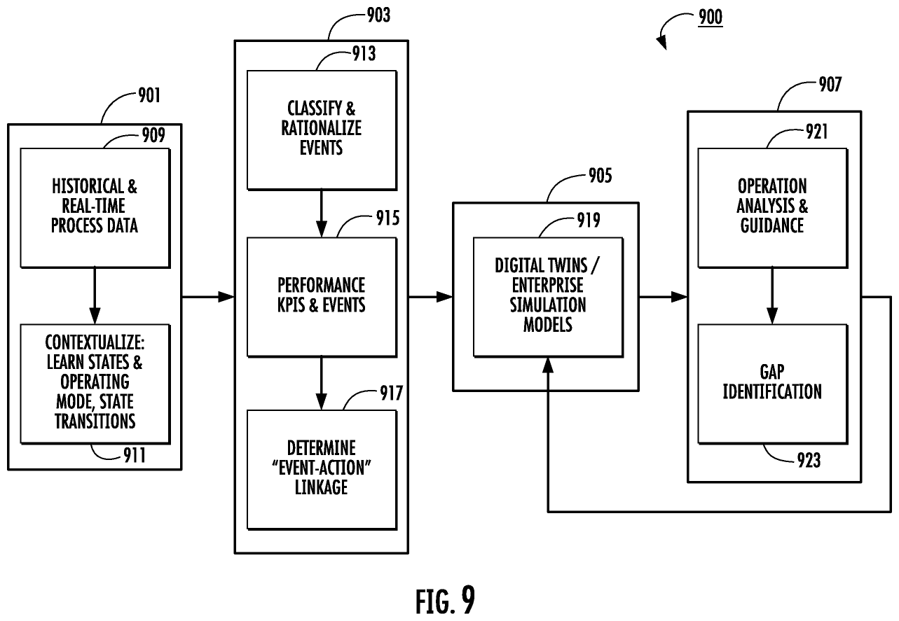

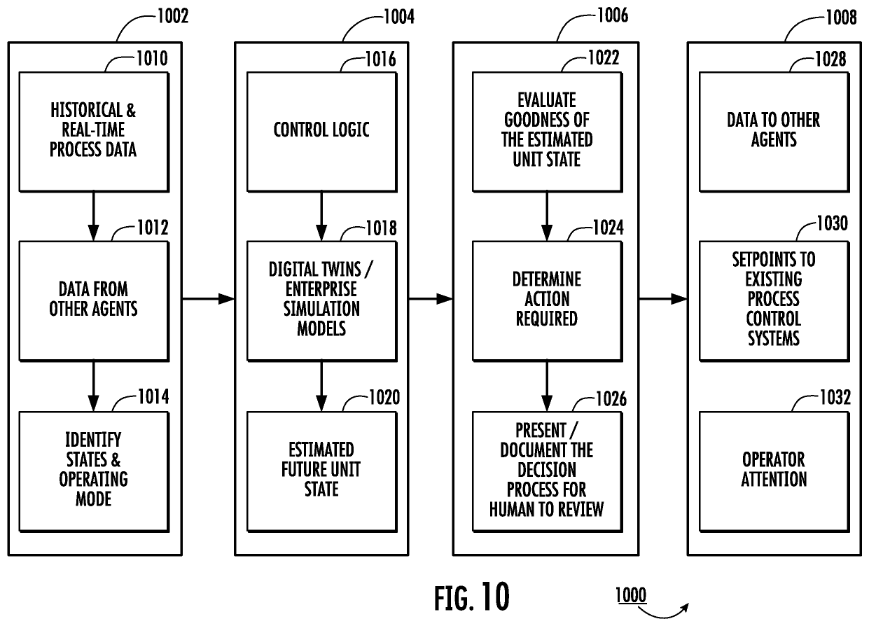

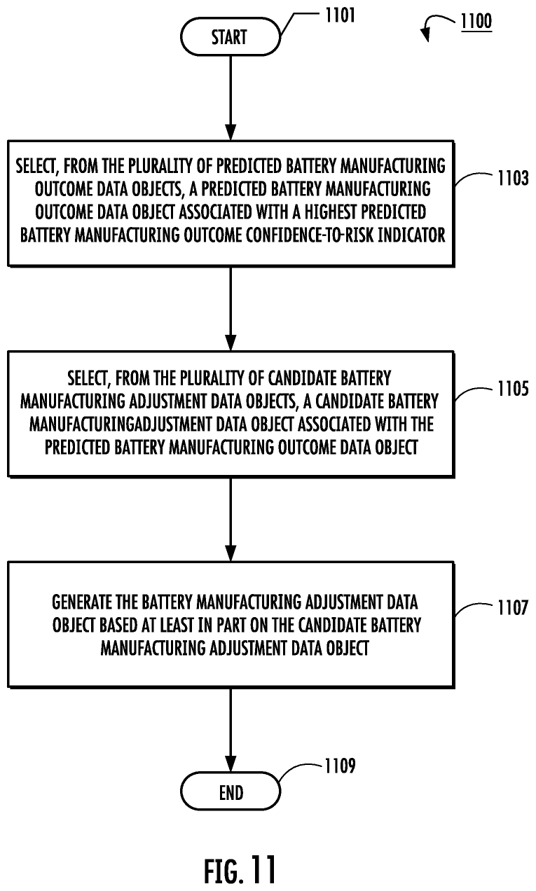

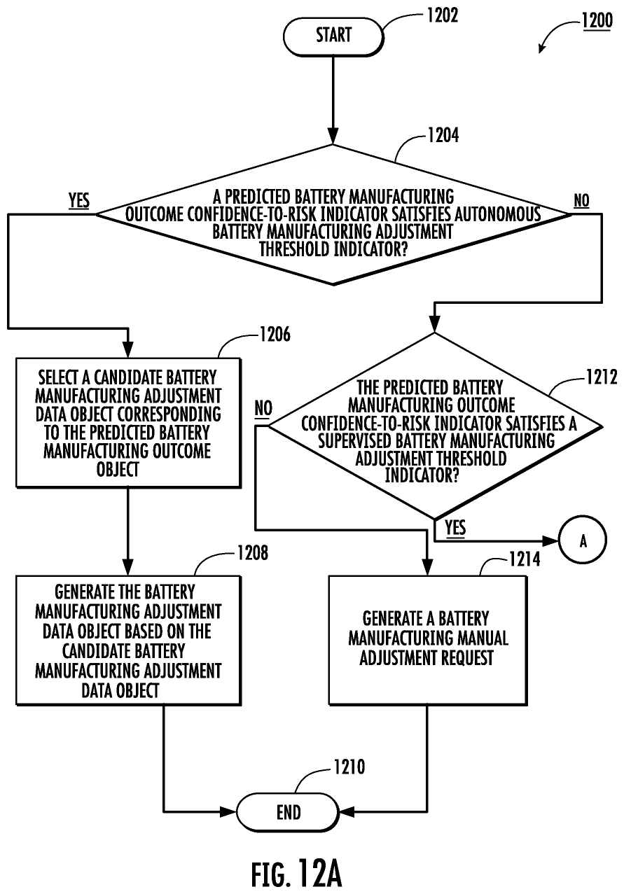

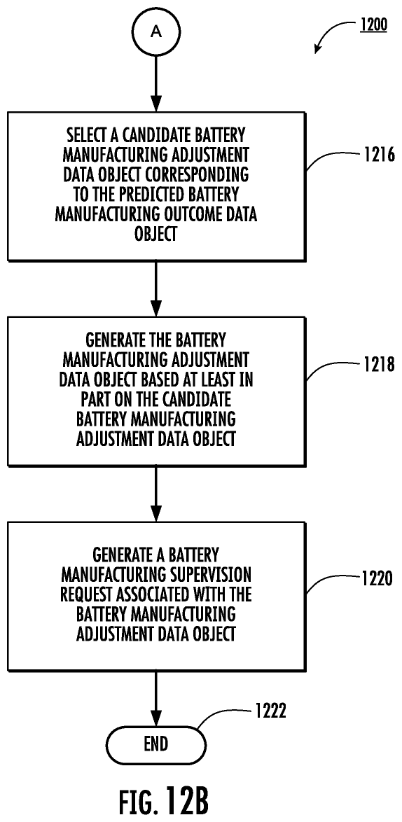

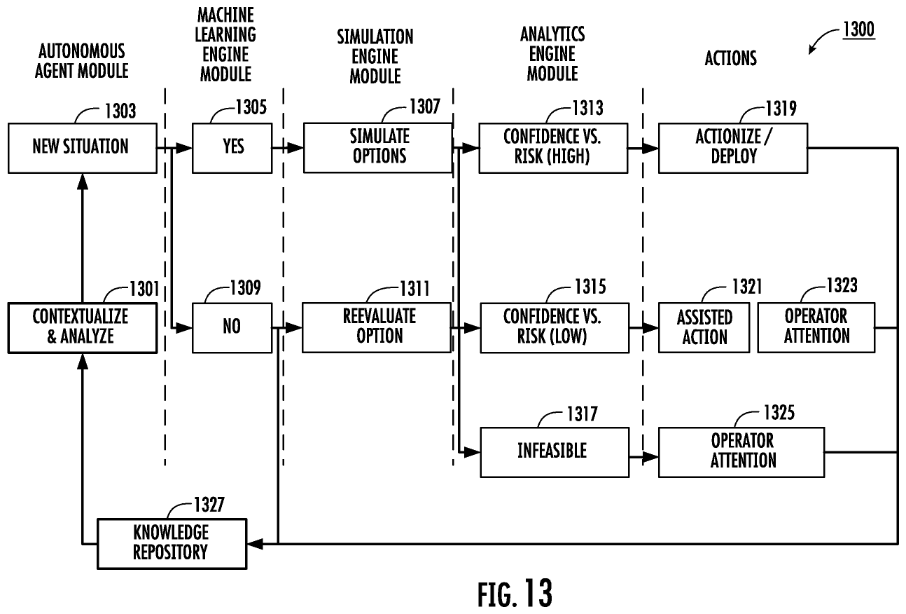

Reference will now be made to FIG. 3, FIG. 4, FIG. 5, FIG. 6, FIG. 7A, FIG. 7B, FIG. 8, FIG. 9, FIG. 10, FIG. 11, FIG. 12A, FIG. 12B, and FIG. 13, which provide flowcharts and diagrams illustrating example steps, processes, procedures, and/or operations associated with an example autonomous platform/system and/or an example intelligent computing device in accordance with various embodiments of the present disclosure.

Embodiments of the present disclosure may be implemented as computer program products that comprise articles of manufacture. Such computer program products may include one or more software components including, for example, applications, software objects, methods, data structures, and/or the like. A software component may be coded in any of a variety of programming languages. An illustrative programming language may be a lower-level programming language such as an assembly language associated with a particular hardware architecture and/or operating system platform/system. A software component comprising assembly language instructions may require conversion into executable machine code by an assembler prior to execution by the hardware architecture and/or platform/system. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Additionally, or alternatively, embodiments of the present disclosure may be implemented as a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media may include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatuses, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

Referring now to FIG. 3, an example machine learning model based battery manufacturing method that provides various technical improvements and advantages in accordance with some embodiments of the present disclosure is illustrated. In particular, the example method shown in FIG. 3 improves the safety level in the battery manufacturing facility while reduces the likelihood of critical errors or failures by generating one or more battery manufacturing adjustment data objects based at least in on one or more machine learning models.

In the example shown in FIG. 3, the example method 300 starts at step/operation 301. In some embodiments, subsequent to and/or response to step/operation 301, the example method 300 proceeds to step/operation 303. At step/operation 303, a computing device (such as, but not limited to, the example intelligent computing device described and illustrated above in connection with FIG. 1 and FIG. 2) may receive a battery manufacturing operation parameter indicator.

As described above, the battery manufacturing operation parameter indicator represents, indicates, and/or comprises one or more battery manufacturing operation parameter values or variables associated with a battery manufacturing operation. In some embodiments, the battery manufacturing operation parameter indicator is associated with a battery manufacturing batch indicator and a battery manufacturing operation indicator.

As described above, the battery manufacturing batch indicator represents, indicates, and/or comprises a batch value associated with battery manufacturing. When a battery manufacturing operation parameter indicator is associated with a battery manufacturing batch indicator, the one or more battery manufacturing operation parameter values or variables are implemented to manufacture the batch of batteries associated with the battery manufacturing batch indicator.

As described above, the battery manufacturing operation indicator represents, indicates, and/or comprises a battery manufacturing operation identifier and/or a battery manufacturing process identifier associated with battery manufacturing. Referring now to FIG. 4, an example block diagram illustrating various example battery manufacturing operations and example battery manufacturing processes in accordance with some embodiments of the present disclosure are illustrated.

In the example shown in FIG. 4, the example battery manufacturing processes associated with battery manufacturing include an ordering and planning process 402, a mastering and modeling process 404, an anode and cathode producing process 406, a production and quality tracking process 408, a packaging and warehousing process 410, and a laboratory process 412.

In the ordering and planning process 402, example battery manufacturing operations include, but not limited to, receiving orders and entering orders operation, checking order status operation, and invoicing orders operation. In some embodiments, each of the example battery manufacturing operations in the ordering and planning process 402 may be associated with a corresponding battery manufacturing operation indicator. In some embodiments, one or more battery manufacturing operation parameter indicators may be associated with one or more example battery manufacturing operations in the ordering and planning process 402.

In the mastering and modeling process 404, example battery manufacturing operations include, but not limited to, machine equipment master operation, production route master operation, product master operation, receipt management operation, raw material master operation, downtime planning operation, and maintenance management operation. In some embodiments, each of the example battery manufacturing operations in the mastering and modeling process 404 may be associated with a corresponding battery manufacturing operation indicator. In some embodiments, one or more battery manufacturing operation parameter indicators may be associated with one or more example battery manufacturing operations in the mastering and modeling process 404.

In the anode and cathode producing process 406, example battery manufacturing operations include, but not limited to, anode bottom drying operation, anode bottom coating operation, anode top drying operation, anode top coating operation, anode mixing operation, cathode bottom drying operation, cathode bottom coating operation, cathode top drying operation, cathode top coating operation, and cathode mixing operation. In some embodiments, each of the example battery manufacturing operations in the anode and cathode producing process 406 may be associated with a corresponding battery manufacturing operation indicator. In some embodiments, one or more battery manufacturing operation parameter indicators may be associated with one or more example battery manufacturing operations in the anode and cathode producing process 406.

In production and quality tracking process 408, example battery manufacturing operations include, but not limited to, calendar operation, slitting operation, vacuum drying operation, stacking operation, welding operation, enclosing operation, and formation/aging operation. In some embodiments, each of the example battery manufacturing operations in the production and quality tracking process 408 may be associated with a corresponding battery manufacturing operation indicator. In some embodiments, one or more battery manufacturing operation parameter indicators may be associated with one or more example battery manufacturing operations in the production and quality tracking process 408.

In the packaging and warehousing process 410, example battery manufacturing operations include, but not limited to, testing operation, product packing operation, warehouse operation, tracking/genealogy operation, shipment operation. In some embodiments, each of the example battery manufacturing operations in the packaging and warehousing process 410 may be associated with a corresponding battery manufacturing operation indicator. In some embodiments, one or more battery manufacturing operation parameter indicators may be associated with one or more example battery manufacturing operations in the packaging and warehousing process 410.

While FIG. 4 illustrates various example battery manufacturing operations and example battery manufacturing processes, it is noted that the scope of the present disclosure is not limited to the example shown in FIG. 4. In accordance with some embodiments of the present disclosure, an example battery manufacturing operation parameter indicator may be associated with one or more additional and/or alternative battery manufacturing operations and/or battery manufacturing processes.

As described above, various embodiments of the present disclosure provide various technical improvements to various technologies and technological fields such as, but not limited to, the field of battery manufacturing. For example, by utilizing battery manufacturing operation parameter indicators, various embodiments may improve the accuracy of capturing the operation status of the battery operation facility and reduce the likelihood of critical errors or failures during manufacturing.

Referring back to FIG. 3, subsequent to step/operation 303, the example method 300 proceeds to step/operation 305. At step/operation 305, a computing device (such as, but not limited to, the example intelligent computing device described and illustrated above in connection with FIG. 1 and FIG. 2) may determine whether the battery manufacturing operation parameter indicator satisfies battery manufacturing parameter threshold indicator.

As described above, the battery manufacturing parameter threshold indicator represents, indicates, and/or comprises a threshold value associated with a battery manufacturing operation parameter. In some embodiments, the battery manufacturing parameter threshold indicator and the battery manufacturing operation parameter indicator are associated with the same battery manufacturing operation indicator.

As an example, the battery manufacturing operation parameter indicator may indicate a weight value associated with the anode coating during battery manufacturing. In such an example, the battery manufacturing operation parameter indicator may be associated with a battery manufacturing operation indicator that indicates a battery manufacturing operation associated with anode coating (for example, the anode bottom drying operation, anode bottom coating operation, anode top drying operation, anode top coating operation, and/or anode mixing operation described above in connection with FIG. 4). In such an example, the battery manufacturing parameter threshold indicator is associated with the same battery manufacturing operation.

For example, if the battery manufacturing operation parameter indicator is associated with the anode bottom coating operation, the battery manufacturing operation parameter indicator indicates the weight of the anode coating during the anode bottom coating operation. In such an example, the battery manufacturing parameter threshold indicator indicates a threshold weight value of the anode coating during the anode bottom coating operation.

If, at step/operation 305, the computing device determines that the battery manufacturing operation parameter indicator does not satisfy the battery manufacturing parameter threshold indicator, the example method 300 proceeds to step/operation 307. At step/operation 307, a computing device (such as, but not limited to, the example intelligent computing device described and illustrated above in connection with FIG. 1 and FIG. 2) may generate a battery manufacturing deviation event data object.

As described above, the battery manufacturing deviation event data object indicates one or more abnormal battery manufacturing processes and/or one or more abnormal battery manufacturing operations.

Continuing from the example above, if the weight value of the anode coating during the anode bottom coating operation does not satisfy the threshold weight value, the computing device may generate a battery manufacturing deviation event data object indicating an abnormal battery manufacturing process/operation associated with the anode coating.

In some embodiments, the battery manufacturing operation parameter indicator associated with step/operation 305 is associated with a battery manufacturing batch indicator. In some embodiments, the battery manufacturing deviation event data object comprises not only the battery manufacturing operation parameter indicator associated with step/operation 305, but also a plurality of additional battery manufacturing operation parameter indicators that is associated with the same battery manufacturing batch indicator. In such an example, the plurality of additional battery manufacturing operation parameter indicators is associated with a plurality of additional battery manufacturing operation indicators that is different from the battery manufacturing operation indicator associated with the battery manufacturing operation parameter indicator associated with step/operation 305.

Continuing from the example above, the battery manufacturing deviation event data object may comprise a battery manufacturing operation parameter indicator that indicates the weight of the anode coating during the anode bottom coating operation, as well as additional battery manufacturing operation parameter indicators that are associated with same battery manufacturing batch indicator as that of the battery manufacturing operation parameter indicator but are associated with different battery manufacturing operation indicators from that of the battery manufacturing operation parameter indicator. For example, the additional battery manufacturing operation parameter indicators may comprise a battery manufacturing operation parameter indicator that indicates the quantity of raw materials, setting values associated with the vacuum drying operation, and/or the like.

As described above, various embodiments of the present disclosure provide various technical improvements to various technologies and technological fields such as, but not limited to, the field of manufacturing. For example, by generating battery manufacturing deviation event data object, various embodiments may improve the accuracy of capturing the operation status of the battery manufacturing facility when there is a deviation event.

Referring back to FIG. 3, subsequent to step/operation 307, the example method 300 proceeds to step/operation 309. At step/operation 309, a computing device (such as, but not limited to, the example intelligent computing device described and illustrated above in connection with FIG. 1 and FIG. 2) may generate a battery manufacturing adjustment data object.

In some embodiments, the computing device generates a battery manufacturing adjustment data object based at least in part on inputting the battery manufacturing deviation event data object to one or more machine learning models. For example, the computing device may comprise one or more installed software models. In such an example, the one or more installed software models may comprise one or more machine learning models that are trained to generate battery manufacturing adjustment data objects. Additional details associated with the one or more installed software models are described and illustrated in connection with at least FIG. 5.

Referring back to FIG. 3, in some embodiments, the battery manufacturing adjustment data object may comprise an adjusted battery manufacturing operation parameter indicator. In some embodiments, the adjusted battery manufacturing operation parameter indicator may be applied to the battery manufacturing so as to resolve the abnormal battery manufacturing process and/or operation. For example, the computing device may transmit the adjusted battery manufacturing operation parameter indicator to the one or more battery manufacturing operation devices illustrated in FIG. 1 to adjust the manufacturing operations.

As described above, various embodiments of the present disclosure provide various technical improvements to various technologies and technological fields such as, but not limited to, the field of manufacturing. For example, by generating battery manufacturing adjustment data object, various embodiments of the present disclosure enable automated adjustments of the battery manufacturing facility without manual user interactions and interventions.

Referring back to FIG. 3, subsequent to step/operation 309, the example method 300 proceeds to step/operation 311 and ends.

If, at step/operation 305, the computing device determines that the battery manufacturing operation parameter indicator satisfies the battery manufacturing parameter threshold indicator, the example method 300 proceeds to step/operation 311 and ends.

Referring now to FIG. 5, example data communications between battery manufacturing operation devices 501 and an example intelligent computing device 503 in accordance with some embodiments of the present disclosure are illustrated.

In some embodiments, the battery manufacturing operation devices 501 may transmit battery manufacturing operation parameter indicators to the example intelligent computing device 503. In the example shown in FIG. 5, the example intelligent computing device 503 comprises one or more modules that are in the form of software executed by computer processors. For example, the example intelligent computing device 503 may comprise a control system module 505, a watchdog/trigger module 507, an autonomous agent module 509, a machine learning engine module 511, a mathematical model module 513, an analytics engine module 515, and/or a simulation engine module 517. In some embodiments, the battery manufacturing operation devices 501 may be in data communications with a skill/knowledge/rule data repository 519.

In some embodiments, the control system module 505 is connected to the battery manufacturing process and provides real-time data on different process parameters, which are indicators of the health of the battery manufacturing process. In some embodiments, the watchdog/trigger module 507 comprises an alarm mechanism that provides an alert when there is a deviation of any process parameter from normal operating limits.

In some embodiments, when the trigger from the watchdog/trigger module 507 reaches the autonomous agent module 509 in the instance of a deviation, the autonomous agent module 509 then collects other contextual information from control system module 505. For example, the autonomous agent module 509 collects real-time data on different process parameters.

In some embodiments, the autonomous agent module 509 checks with the machine learning engine module 511 to determine whether a similar deviation had occurred in the past.

In some embodiments, the machine learning engine module 511 explores the skill/knowledge/rule data repository 519 and receives data associated with historic adjustments actions that have been implemented, and then relays data associated with historic adjustments actions to the autonomous agent module 509. In some embodiments, the autonomous agent module 509 relays data associated with historic adjustments actions on to the control system module 505 and/or the user 521 so that the control system module 505 and/or the user 521 can take action based on the historic adjustments to overcome the deviation.

In some embodiments, if the deviation is novel and is not similar to any deviation that had occurred in the past, the autonomous agent module 509 interacts with the analytics engine module 515. In some embodiments, the analytics engine module 515 analyses the deviation using a mathematical model module 513, and identifies the cause of the deviation. In some embodiments, the autonomous agent module 509 then determines the possible actions that can be taken to overcome the situation that the deviation has caused, so that the process outcome is still of expected specification. In some embodiments, the analytics engine module 515 can be further expanded to determine a classification associated with the deviation so as to identify the appropriate mathematical model from the mathematical model module 513.

In some embodiments, the possible actions/recommendations are then run through the simulation engine module 517 using the mathematical model module 513, loops back with the analytics engine module 515 to determine the best possible action.

In some embodiments, the best-chosen option is then relayed on to the autonomous agent module 509 for actioning. In some embodiments, the best-chosen option is relayed on to the user 521 for actioning until the machine learning models are sufficiently trained and/or the user becomes confident in the recommendations from the machine learning modes. In some embodiments, the machine learning models constantly learn the actions and update the skill/knowledge/rule data repository 519 for future reference.

Referring now to FIG. 6, an example machine learning model based battery manufacturing method 600 that provides various technical improvements and advantages in accordance with some embodiments of the present disclosure is illustrated.

As described above, various embodiments of the present disclosure may utilize one or more machine learning models to generate battery manufacturing adjustment data objects. In some embodiments, the one or more machine learning models comprise a deviation event similarity determination machine learning model, and FIG. 6 illustrates an example method of determining similarities between a battery manufacturing deviation event data object and a plurality of historical battery manufacturing deviation event data objects.

In the example shown in FIG. 6, the example method 600 starts at step/operation 602. In some embodiments, subsequent to and/or response to step/operation 602, the example method 600 proceeds to step/operation 604. At step/operation 604, a computing device (such as, but not limited to, the example intelligent computing device described and illustrated above in connection with FIG. 1 and FIG. 2) may receive, from a battery manufacturing deviation event repository, a plurality of historical battery manufacturing deviation event data objects.

In some embodiments, the plurality of historical battery manufacturing deviation event data objects are associated with the same battery manufacturing facility. In some embodiments, each of the plurality of historical battery manufacturing deviation event data objects is associated with a historical battery manufacturing batch indicator. For example, the historical battery manufacturing batch indicator may indicate a production of batteries that has been completed in the past.

Referring back to FIG. 6, subsequent to and/or response to step/operation 604, the example method 600 proceeds to step/operation 606. At step/operation 606, a computing device (such as, but not limited to, the example intelligent computing device described and illustrated above in connection with FIG. 1 and FIG. 2) may input the battery manufacturing deviation event data object and the plurality of historical battery manufacturing deviation event data objects to a deviation event similarity determination machine learning model.

As described above, the deviation event similarity determination machine learning model may be trained to generate one or more deviation event similarity indicators that represents, indicates, and/or comprises a deviation event similarity level between a battery manufacturing deviation event data object and one or more historical battery manufacturing deviation event data objects.

As described above, various embodiments of the present disclosure provide various technical improvements to various technologies and technological fields such as, but not limited to, the field of manufacturing. For example, by implementing deviation event similarity determination machine learning model to generate deviation event similarity indicators, various embodiments may improve the accuracy of determining whether or how much a deviation event is similar to a historical deviation event and reduce the time for making such a determination.

Referring back to FIG. 6, subsequent to and/or response to step/operation 606, the example method 600 proceeds to step/operation 608. At step/operation 608, a computing device (such as, but not limited to, the example intelligent computing device described and illustrated above in connection with FIG. 1 and FIG. 2) may receive, from the deviation event similarity determination machine learning model, a plurality of deviation event similarity indicators.

As described above in connection with step/operation 606, the battery manufacturing deviation event data object and the plurality of historical battery manufacturing deviation event data objects are provided as inputs to the deviation event similarity determination machine learning model. In some embodiments, each of the plurality of deviation event similarity indicators indicates a corresponding deviation event similarity level between the battery manufacturing deviation event data object and one of the plurality of historical battery manufacturing deviation event data objects.

Referring back to FIG. 6, subsequent to and/or response to step/operation 608, the example method 600 proceeds to step/operation 610 and ends.

Referring now to FIG. 7A and FIG. 7B, an example machine learning model based battery manufacturing method 700 that provides various technical improvements and advantages in accordance with some embodiments of the present disclosure is illustrated.

As illustrated above in connection with at least FIG. 6, a deviation event similarity indicator may be generated in accordance with some embodiments of the present disclosure. For example, the deviation event similarity indicator may be associated with the battery manufacturing deviation event data object and a historical battery manufacturing deviation event data object from the plurality of historical battery manufacturing deviation event data objects. In this example, the deviation event similarity indicator indicates a deviation event similarity level between the battery manufacturing deviation event data object and the historical battery manufacturing deviation event data object, and the example machine learning model based battery manufacturing method 700 shown in FIG. 7A and FIG. 7B illustrates unitizing the deviation event similarity indicator to generate the battery manufacturing adjustment data object.

In the example shown in FIG. 7A, the example method 700 starts at step/operation 701. In some embodiments, subsequent to and/or response to step/operation 701, the example method 700 proceeds to step/operation 703. At step/operation 703, a computing device (such as, but not limited to, the example intelligent computing device described and illustrated above in connection with FIG. 1 and FIG. 2) may determine whether the deviation event similarity indicator satisfies a deviation event similarity threshold indicator.

As described above, the deviation event similarity threshold indicator represents, indicates, and/or comprises a deviation event similarity threshold between a battery manufacturing deviation event data object and a historical battery manufacturing deviation event data object.

If, at step/operation 703, the computing device determines that the deviation event similarity indicator satisfies the deviation event similarity threshold indicator, the example method 700 proceeds to step/operation 705. At step/operation 705, a computing device (such as, but not limited to, the example intelligent computing device described and illustrated above in connection with FIG. 1 and FIG. 2) may receive a historical battery manufacturing adjustment data object corresponding to the historical battery manufacturing deviation event data object.

As described above, the battery manufacturing deviation event repository may store a plurality of historical battery manufacturing deviation event data objects and a plurality of historical battery manufacturing adjustment data objects. In some embodiments, a historical battery manufacturing deviation event data object from the plurality of historical battery manufacturing deviation event data objects is associated with a historical battery manufacturing adjustment data object from the plurality of historical battery manufacturing adjustment data objects. For example, the historical battery manufacturing adjustment data object may indicate one or more adjustments to one or more battery manufacturing operation parameter indicators in response to the abnormal battery manufacturing processes and/or abnormal battery manufacturing operations described in the historical battery manufacturing deviation event data object.

Referring back to FIG. 7A, subsequent to and/or response to step/operation 705, the example method 700 proceeds to step/operation 707. At step/operation 707, a computing device (such as, but not limited to, the example intelligent computing device described and illustrated above in connection with FIG. 1 and FIG. 2) may generate the battery manufacturing adjustment data object based at least in part on the historical battery manufacturing adjustment data object.

In some embodiments, when the computing device determines a deviation event similarity level between a battery manufacturing deviation event data object and a historical battery manufacturing deviation event data object satisfies the deviation event similarity threshold, the computing device determines that the battery manufacturing deviation event data object and the historical battery manufacturing deviation event data object are sufficiently similar. As such, the computing device generates the battery manufacturing adjustment data object based on the historical battery manufacturing adjustment data object that corresponds to the historical battery manufacturing deviation event data object. For example, the battery manufacturing adjustment data object may indicate one or more adjustments to one or more battery manufacturing operation parameter indicators, similar to the one or more adjustments described in the historical battery manufacturing adjustment data object.

Referring back to FIG. 7A, subsequent to and/or response to step/operation 707, the example method 700 proceeds to step/operation 709 and ends.

If, at step/operation 703, the computing device determines that the deviation event similarity indicator does not satisfy the deviation event similarity threshold indicator, the example method 700 proceeds to step/operation 711. At step/operation 711, a computing device (such as, but not limited to, the example intelligent computing device described and illustrated above in connection with FIG. 1 and FIG. 2) may input the battery manufacturing deviation event data object to the deviation event classification estimation machine learning model.

As described above, various embodiments of the present disclosure may utilize one or more machine learning models to generate battery manufacturing adjustment data objects. In some embodiments, the one or more machine learning models comprise a deviation event classification estimation machine learning model. In such an example, the deviation event classification estimation machine learning model is trained to generate one or more estimated deviation event classification indicators that represent, indicate, and/or comprise an estimated deviation event classification associated with the battery manufacturing deviation event data object.

As described above, various embodiments of the present disclosure provide various technical improvements to various technologies and technological fields such as, but not limited to, the field of manufacturing. For example, by utilizing the deviation event classification estimation machine learning model, various embodiments may improve the accuracy of determining the type or classification of the deviation event.

Referring back to FIG. 7A, subsequent to and/or response to step/operation 711, the example method 700 proceeds to step/operation 713. At step/operation 713, a computing device (such as, but not limited to, the example intelligent computing device described and illustrated above in connection with FIG. 1 and FIG. 2) may receive an estimated deviation event classification indicator and a plurality of candidate battery manufacturing adjustment data objects.

For example, an example estimated deviation event classification indicator may indicate that the battery manufacturing deviation event data object is associated with an incidental deviation. Additionally, or alternatively, an example estimated deviation event classification indicator may indicate that the battery manufacturing deviation event data object is associated with a minor deviation. Additionally, or alternatively, an example estimated deviation event classification indicator may indicate that the battery manufacturing deviation event data object is associated with a major deviation. Additionally, or alternatively, an example estimated deviation event classification indicator may indicate that the battery manufacturing deviation event data object is associated with a critical deviation. Additionally, or alternatively, the example estimated deviation event classification indicator may indicate that the battery manufacturing deviation event data object is associated with other types of deviations.

In some embodiments, the deviation event classification estimation machine learning model may be trained to generate a plurality of candidate battery manufacturing adjustment data objects based at least in part on the one or more estimated deviation event classification indicators.

In some embodiments, each of the plurality of candidate battery manufacturing adjustment data objects comprises at least one candidate adjusted battery manufacturing operation parameter indicator.

For example, based on the example estimated deviation event classification indicator indicating an incidental deviation, the deviation event classification estimation machine learning model may generate a candidate battery manufacturing adjustment data object that includes a candidate adjusted battery manufacturing operation parameter indicator, and the candidate adjusted battery manufacturing operation parameter indicator is similar to a historical adjusted battery manufacturing operation parameter indicator of a historical battery manufacturing adjustment data object that corresponds to a historical battery manufacturing deviation event data objects that is also associated with an incidental deviation. In such an example, the deviation event classification estimation machine learning model may be trained using historical battery manufacturing deviation event data objects that are also associated with the incidental deviations.

Additionally, or alternatively, based on the example estimated deviation event classification indicator indicating a minor deviation, the deviation event classification estimation machine learning model may generate a candidate battery manufacturing adjustment data object that includes a candidate adjusted battery manufacturing operation parameter indicator, and the candidate adjusted battery manufacturing operation parameter indicator is similar to a historical adjusted battery manufacturing operation parameter indicator of a historical battery manufacturing adjustment data object that corresponds to a historical battery manufacturing deviation event data objects that is also associated with a minor deviation. In such an example, the deviation event classification estimation machine learning model may be trained using historical battery manufacturing deviation event data objects that are also associated with the minor deviations.

Additionally, or alternatively, based on the example estimated deviation event classification indicator indicating a major deviation, the deviation event classification estimation machine learning model may generate a candidate battery manufacturing adjustment data object that includes a candidate adjusted battery manufacturing operation parameter indicator, and the candidate adjusted battery manufacturing operation parameter indicator is similar to a historical adjusted battery manufacturing operation parameter indicator of a historical battery manufacturing adjustment data object that corresponds to a historical battery manufacturing deviation event data objects that is also associated with a major deviation. In such an example, the deviation event classification estimation machine learning model may be trained using historical battery manufacturing deviation event data objects that are also associated with the major deviations.

Additionally, or alternatively, based on the example estimated deviation event classification indicator indicating a critical deviation, the deviation event classification estimation machine learning model may generate a candidate battery manufacturing adjustment data object that includes a candidate adjusted battery manufacturing operation parameter indicator, and the candidate adjusted battery manufacturing operation parameter indicator is similar to a historical adjusted battery manufacturing operation parameter indicator of a historical battery manufacturing adjustment data object that corresponds to a historical battery manufacturing deviation event data objects that is also associated with a critical deviation. In such an example, the deviation event classification estimation machine learning model may be trained using historical battery manufacturing deviation event data objects that are also associated with the critical deviations.

Referring back to FIG. 7A, subsequent to and/or response to step/operation 713, the example method 700 proceeds to block A, which connects FIG. 7A to FIG. 7B. Referring now to FIG. 7B, subsequent to and/or response to block A (for example, subsequent to and/or response to step/operation 713), the example method 700 proceeds to step/operation 715. At step/operation 715, a computing device (such as, but not limited to, the example intelligent computing device described and illustrated above in connection with FIG. 1 and FIG. 2) may input the plurality of candidate battery manufacturing adjustment data objects to the battery manufacturing outcome prediction machine learning model.

As described above, various embodiments of the present disclosure may utilize one or more machine learning models to generate battery manufacturing adjustment data objects. In some embodiments, the one or more machine learning models comprise a battery manufacturing outcome prediction machine learning model.

In some embodiments, the battery manufacturing outcome prediction machine learning model is trained to generate one or more predicted battery manufacturing outcome data objects that comprise data and/or information associated with simulated outcomes after one or more adjustments described in a candidate battery manufacturing adjustment data object are implemented in the battery manufacturing facility. For example, the battery manufacturing outcome prediction machine learning model may be in the form of a simulation model that simulates the outcomes of battery manufacturing if the adjustments described in the candidate battery manufacturing adjustment data object are implemented.

As described above, various embodiments of the present disclosure provide various technical improvements to various technologies and technological fields such as, but not limited to, the field of battery manufacturing. For example, by utilizing the battery manufacturing outcome prediction machine learning model, various embodiments of the present disclosure may accurately predict one or more outcomes associated with one or more potential adjustments to the battery manufacturing process, allowing an operator to preview such predicted outcomes prior to implementing such adjustments, thereby reducing the likelihood of critical errors or failures during battery manufacturing.

Referring back to FIG. 7B, subsequent to and/or response to step/operation 715, the example method 700 proceeds to step/operation 717. At step/operation 717, a computing device (such as, but not limited to, the example intelligent computing device described and illustrated above in connection with FIG. 1 and FIG. 2) may receive a plurality of predicted battery manufacturing outcome data objects associated with the plurality of candidate battery manufacturing adjustment data objects.

In some embodiments, the plurality of predicted battery manufacturing outcome data objects associated with the plurality of candidate battery manufacturing adjustment data objects are received from the battery manufacturing outcome prediction machine learning model.

For example, the battery manufacturing outcome prediction machine learning model generates one predicted battery manufacturing outcome data object for each of the plurality of candidate battery manufacturing adjustment data objects that is provided to the battery manufacturing outcome prediction machine learning model.

Referring back to FIG. 7B, subsequent to and/or response to step/operation 717, the example method 700 proceeds to step/operation 719. At step/operation 719, a computing device (such as, but not limited to, the example intelligent computing device described and illustrated above in connection with FIG. 1 and FIG. 2) may generate the battery manufacturing adjustment data object.

In some embodiments, the battery manufacturing adjustment data object is generated based at least in part on the plurality of candidate battery manufacturing adjustment data objects that are generated by the deviation event classification estimation machine learning model at step/operation 713 and the plurality of predicted battery manufacturing outcome data objects that are generated by the battery manufacturing outcome prediction machine learning model at step/operation 715. For example, the computing device may select one of the plurality of candidate battery manufacturing adjustment data objects as the battery manufacturing adjustment data object. Additional details are described herein, including, but not limited to, at least in connection with FIG. 11 to FIG. 12B.

Referring back to FIG. 7B, subsequent to and/or response to step/operation 719, the example method 700 proceeds to step/operation 721 and ends.

Referring now to FIG. 8, an example machine learning model based battery manufacturing method that provides various technical improvements and advantages in accordance with some embodiments of the present disclosure is provided. In particular, FIG. 8 illustrates both the training process 802 of the machine learning models and the runtime process 804 of the machine learning models.

In the example shown in FIG. 8, the training process 802 includes at least step/operation 806, step/operation 808, step/operation 810, step/operation 812, step/operation 814, step/operation 816, step/operation 820, and step/operation 822.

At step/operation 806, a computing device (such as, but not limited to, the example intelligent computing device described and illustrated above in connection with FIG. 1 and FIG. 2) may receive historical and real-time process data associated with the battery manufacturing facility.

At step/operation 808, a computing device (such as, but not limited to, the example intelligent computing device described and illustrated above in connection with FIG. 1 and FIG. 2) may implement machine learning to determine the state and operating modes associated with the battery manufacturing facility. For example, the computing device may implement one or more algorithms to determine plant state and operating mode to maximize the accuracy of the above solutions.

At step/operation 810, a computing device (such as, but not limited to, the example intelligent computing device described and illustrated above in connection with FIG. 1 and FIG. 2) may implement machine learning to classify the deviation event associated with the battery manufacturing facility. For example, the computing device may provide algorithms for data driven automatic labeling of rare events (for example, large ratio of features to outcome) in multivariate data. In such an example, doing so enables training of the machine learning models on the rare event data and use the trained machine learning models to classify future events.

At step/operation 812, a computing device (such as, but not limited to, the example intelligent computing device described and illustrated above in connection with FIG. 1 and FIG. 2) may implement machine learning to perform event rationalization.

For example, the computing device may enable faster root cause analysis using algorithms to identify similarities between the different event groups, and analyze whether the control response was consistent for similar situations during the group. In some embodiments, the computing device may implement analytical algorithms to analyze similarity across different event groups by pattern searching for multiple process tags, consistency and effectiveness of the control response in terms of the action taken, time to respond by pattern searching for multiple events (such as, but not limited to, alarms and actions associated with the battery manufacturing deviation events) and integrating with documentation and enforcement (for example, for checking the alarm response time as well as correctness of the response to the battery manufacturing deviation events).

At step/operation 814, a computing device (such as, but not limited to, the example intelligent computing device described and illustrated above in connection with FIG. 1 and FIG. 2) may implement machine learning to analyze Key Performance Indicator (KPI)s and event analysis. For example, the computing device may implement algorithms to relate KPIs (performance, efficiencies, emissions) to process data including alarms. In such an example, the computing device may minimize lost opportunities to take corrective actions to maintain performance and safety when process issues are only recognized in real time as they are occurring.

At step/operation 816, a computing device (such as, but not limited to, the example intelligent computing device described and illustrated above in connection with FIG. 1 and FIG. 2) may determine one or more event action linkages. For example, the computing device may determine one or more linkages between the historical battery manufacturing deviation event data objects and the historical battery manufacturing adjustment data objects.

In some embodiments, the computing device may determine the “event-action” linkages based at least in part on the operator guidelines or standard operating procedures, which will have such definitions of “Alarm-Operator action”. However, such information may not be up to date or may not be available in a compatible digital format.

In some embodiments, the computing device may function as an alarm optimization system, competency assessment system, and/or the like that auto-identify “alarm-operator action” pairs from the information available within the DCS.

In some embodiments, the computing device may implement one or more probabilistic models to derive the best operator/control system response for an alarm resolution based on the relation between the device that went into alarm (for example, the battery manufacturing operation device that causes the deviation) and the devices that are operated for resolving the alarm.

At step/operation 818, a computing device (such as, but not limited to, the example intelligent computing device described and illustrated above in connection with FIG. 1 and FIG. 2) may build the enterprise simulation models.

For example, while analyzing and identifying the cause a battery manufacturing facility upset or an abnormal situation in the battery manufacturing facility, algorithms using simulation models enable the multi-agent autonomous system to resolve the deviation holistically by enabling the identification of causes and issues and considering asset/process relationships (which may not have previously been designed into the operation procedure). Instead of looking at a small slice of operation data, such enterprise simulation models enable the autonomous system to use contextually relevant plant state and history. For example, building the enterprise simulation models may include highlighting knowledge related to the particular feed type or product grade (for example, but not limited to, polymer grade) being produced by the operations. In some embodiments, building the enterprise simulation models may enable the multi-agent autonomous system to take control actions based on the most optimal previous situation.

In some embodiments, the computing device provides curated knowledge management (such as, but not limited to, enabling the multi-agent autonomous system to refer to the best control response when resolving abnormal situations). In some embodiments, computing devices enable shared learning when building the enterprise simulation models.

At step/operation 820, a computing device (such as, but not limited to, the example intelligent computing device described and illustrated above in connection with FIG. 1 and FIG. 2) may implement machine learning models to conduct operation analysis and generate operational guidance.

For example, the computing device may implement machine learning models to identify the skill and knowledge gaps when operators, maintenance engineers, system engineers and field engineers perform their tasks by analyzing the data recorded and accumulated in DCS, asset managers, change management systems and the records of configuration. In some embodiments, the analysis of these data and the access of the real-time process data can provide guidelines to the multi-agent autonomous system to respond to the process alarms in an efficient and safe manner.

At step/operation 822, a computing device (such as, but not limited to, the example intelligent computing device described and illustrated above in connection with FIG. 1 and FIG. 2) may implement machine learning to perform gap identification.

For example, some operators may perform better than others at managing alarms, and maintaining consistency and uniformity can be a challenge. In some embodiments, alarms and change logs are available in the history of the battery manufacturing facility, history data are available in the DCS, and/or historians have the information of the process abnormalities and the operator actions performed in response to such deviations. In some embodiments, analysis of this data using analytic techniques reveals the benchmark sequences of operator actions that need to be performed and the gaps in the operator performance to respond to process variable deviations. In some embodiments, gaps in operator performance can be filled with the appropriate guidance for an eventual better plant operation.

In the example shown in FIG. 8, the runtime process 804 includes at least step/operation 824, step/operation 826, step/operation 828, step/operation 830, step/operation 832, step/operation 834, step/operation 836, step/operation 838, and step/operation 840.

At step/operation 824, a computing device (such as, but not limited to, the example intelligent computing device described and illustrated above in connection with FIG. 1 and FIG. 2) may receive real-time process data and KPIs associated with the battery manufacturing facility.

At step/operation 826, a computing device (such as, but not limited to, the example intelligent computing device described and illustrated above in connection with FIG. 1 and FIG. 2) may receive data from other autonomous agent models associated with other battery manufacturing operation indicators.

At step/operation 828, a computing device (such as, but not limited to, the example intelligent computing device described and illustrated above in connection with FIG. 1 and FIG. 2) may determine the state of a unit in the battery manufacturing facility.

At step/operation 830, a computing device (such as, but not limited to, the example intelligent computing device described and illustrated above in connection with FIG. 1 and FIG. 2) may estimate the state of the unit after the proposed adjustments are implemented. For example, the computing device may replay and evaluate operator changes. In some embodiments, the computing device may emulate the “platinum operator” (e.g. what the best operator could do if at their best all the time). In some embodiments, the computing device may run an advanced mathematical representation of the process in parallel that keeps up with the current system state to ensure the mathematical representation is always mirrored.

As such, various embodiments of the present disclosure may provide various technical benefits and advantages such as, but not limited to, allow the autonomic controller to “try” actions and see the outcome before acting on the system, allowing the operator to preview outcomes of actions on the process to enable operators to obtain answers to “what if I did this?,” allowing the operator to explore potential actions without affecting the on-stream process, enabling experiential learning, collaborating in real time to optimize process and cement the learning, and dispelling the myth of “we always do it this way” by looking for better options.

At step/operation 832, a computing device (such as, but not limited to, the example intelligent computing device described and illustrated above in connection with FIG. 1 and FIG. 2) may evaluate goodness of the estimated unit state. For example, the computing device may determine a goodness level associated with the estimated unit state. At step/operation 834, a computing device (such as, but not limited to, the example intelligent computing device described and illustrated above in connection with FIG. 1 and FIG. 2) may implement machine learning to evaluate and/or critic the goodness of the estimated unit state from step/operation 832.

At step/operation 836, a computing device (such as, but not limited to, the example intelligent computing device described and illustrated above in connection with FIG. 1 and FIG. 2) may determine the action that is required in response to the deviation event.

At step/operation 838, a computing device (such as, but not limited to, the example intelligent computing device described and illustrated above in connection with FIG. 1 and FIG. 2) may transmit data associated with the adjustments of the battery manufacturing operation parameter indicators to other autonomous agent modules associated with other battery manufacturing operation indicators.

At step/operation 840, a computing device (such as, but not limited to, the example intelligent computing device described and illustrated above in connection with FIG. 1 and FIG. 2) may send setpoints to existing process control systems.

At step/operation 842, a computing device (such as, but not limited to, the example intelligent computing device described and illustrated above in connection with FIG. 1 and FIG. 2) may analyze the safety associated with the implementation of the adjusted battery manufacturing operation parameter indicators.

Referring now to FIG. 9, an example machine learning model based battery manufacturing method 900 that provides various technical improvements and advantages in accordance with some embodiments of the present disclosure is provided. In particular, FIG. 9 illustrates an example training process of machine learning models based on the training process 802 described in connection with FIG. 8 above.

At step/operation 901, a computing device (such as, but not limited to, the example intelligent computing device described and illustrated above in connection with FIG. 1 and FIG. 2) may ingest and/or enrich battery manufacturing process data and/or information associated with the battery manufacturing facility, and may identify the plant states and operation modes associated with the battery manufacturing facility. For example, the computing device may receive historical and real-time process data associated with the battery manufacturing facility at step/operation 909, and may contextualize battery manufacturing process data and/or information based on leaning the state, operating modes, state transitions, and/or the like associated with the battery manufacturing facility at step/operation 911.

At step/operation 903, a computing device (such as, but not limited to, the example intelligent computing device described and illustrated above in connection with FIG. 1 and FIG. 2) may link process events to process data, KPIs, and control actions. For example, the computing device may classify and rationalize events at step/operation 913, determine performance KPIs and events at step/operation 915, and determine “event-action” linkage at step/operation 917.

At step/operation 905, a computing device (such as, but not limited to, the example intelligent computing device described and illustrated above in connection with FIG. 1 and FIG. 2) may generate a suite of mathematical models, decisions trees, and knowledge graphs associated with the battery manufacturing facility. For example, the computing device may generate a digital twin and/or enterprise simulation models associated with the battery manufacturing facility at step/operation 919.

At step/operation 907, a computing device (such as, but not limited to, the example intelligent computing device described and illustrated above in connection with FIG. 1 and FIG. 2) may utilize reinforcement learning of the digital twin and/or enterprise simulation models generated at step/operation 905 using feedback from the operators of the battery manufacturing facility and/or the autonomous agent model described herein. For example, the computing device may provide operation analysis and guidance at step/operation 921 and identify any gaps between the battery manufacturing adjustment data objects and the user actions at step/operation 923.

Referring now to FIG. 10, an example machine learning model based battery manufacturing method 1000 that provides various technical improvements and advantages in accordance with some embodiments of the present disclosure is provided. In particular, FIG. 10 illustrates an example runtime process of the machine learning models based on the runtime process 804 described in connection with FIG. 8.

At step/operation 1002, a computing device (such as, but not limited to, the example intelligent computing device described and illustrated above in connection with FIG. 1 and FIG. 2) may collect runtime process data, relevant data from other autonomous agent modules associated with other battery manufacturing operation indicators, and generate subsets of runtime process data based on the process state and operating modes associated with the battery manufacturing facility. For example, the computing device may receive historical and real-time process data at step/operation 1010, receive data from other autonomous agent modules associated with other battery manufacturing operation indicators at step/operation 1012, and identify states and operating modes associated with the battery manufacturing facility at step/operation 1014.

At step/operation 1004, a computing device (such as, but not limited to, the example intelligent computing device described and illustrated above in connection with FIG. 1 and FIG. 2) may link process events, proceed data, and KPIs to required control actions. For example, the computing device may provide control logic at step/operation 1016, retrieve digital twins and enterprise simulation models at step/operation 1018, and provide estimated further unit state at step/operation 1020.

At step/operation 1006, a computing device (such as, but not limited to, the example intelligent computing device described and illustrated above in connection with FIG. 1 and FIG. 2) may evaluate the effects of the proposed control actions on the larger network or systems associated with the battery manufacturing facility. For example, the computing device may evaluate the goodness of the unit state at step/operation 1022, determine the required action at step/operation 1024, and present or document the decision process on a display of a computing device for an operator to review at step/operation 1026.

At step/operation 1008, a computing device (such as, but not limited to, the example intelligent computing device described and illustrated above in connection with FIG. 1 and FIG. 2) may send process setpoints and relevant data to other autonomous agent models, and may request operator engagement if needed. For example, the computing device may send data to other autonomous agent models at step/operation 1028, send setpoints to existing process control systems at step/operation 1030, and request operator attention at step/operation 1032.

Referring now to FIG. 11, an example machine learning model based battery manufacturing method 1100 that provides various technical improvements and advantages in accordance with some embodiments of the present disclosure is illustrated.

In the example shown in FIG. 11, the example method 1100 starts at step/operation 1101. In some embodiments, subsequent to and/or response to step/operation 1101, the example method 1100 proceeds to step/operation 1103. At step/operation 1103, a computing device (such as, but not limited to, the example intelligent computing device described and illustrated above in connection with FIG. 1 and FIG. 2) may select, from the plurality of predicted battery manufacturing outcome data objects, a predicted battery manufacturing outcome data object associated with a highest predicted battery manufacturing outcome confidence-to-risk indicator.

In some embodiments, the plurality of predicted battery manufacturing outcome data objects is associated with a plurality of predicted battery manufacturing outcome confidence-to-risk indicators. For example, the battery manufacturing outcome prediction machine learning model may be trained to generate a predicted battery manufacturing outcome confidence-to-risk indicator for each of the predicted battery manufacturing outcome data objects.

As described above, the predicted battery manufacturing outcome confidence-to-risk indicator refers to an indicator that represents, indicates, and/or comprises a ratio value between a confidence value and a risk value associated with a predicted battery manufacturing outcome data object. The higher the predicted battery manufacturing outcome confidence-to-risk indicator, the more confidence that the predicted battery manufacturing outcome is a positive outcome (for example, more likely to resolve the abnormal processes/operations) and the less likelihood of risks associated with the predicted battery manufacturing outcome (for example, less likely that there is additional abnormal processes/operations).

In some embodiments, the computing device compares the plurality of predicted battery manufacturing outcome confidence-to-risk indicators, determines the highest predicted battery manufacturing outcome confidence-to-risk indicator, and selects the predicted battery manufacturing outcome data object from the plurality of predicted battery manufacturing outcome data objects that is associated with the highest predicted battery manufacturing outcome confidence-to-risk indicator.

Referring back to FIG. 11, subsequent to and/or response to step/operation 1103, the example method 1100 proceeds to step/operation 1105. At step/operation 1105, a computing device (such as, but not limited to, the example intelligent computing device described and illustrated above in connection with FIG. 1 and FIG. 2) may select, from the plurality of candidate battery manufacturing adjustment data objects, a candidate battery manufacturing adjustment data object associated with the predicted battery manufacturing outcome data object.

As described above, each predicted battery manufacturing outcome data object is associated with a candidate battery manufacturing adjustment data object. In some embodiments, the computing device selects a candidate battery manufacturing adjustment data object from the plurality of candidate battery manufacturing adjustment data objects that is associated with the predicted battery manufacturing outcome data object.

Referring back to FIG. 11, subsequent to and/or response to step/operation 1105, the example method 1100 proceeds to step/operation 1107. At step/operation 1107, a computing device (such as, but not limited to, the example intelligent computing device described and illustrated above in connection with FIG. 1 and FIG. 2) may generate the battery manufacturing adjustment data object based at least in part on the candidate battery manufacturing adjustment data object.

In some embodiments, the computing device generates the battery manufacturing adjustment data object based at least in part on the candidate battery manufacturing adjustment data object. For example, the battery manufacturing adjustment data object may comprise one or more adjusted battery manufacturing operation parameter indicators that are the same and/or similar to the battery manufacturing operation parameter indicators described in the candidate battery manufacturing adjustment data object selected at step/operation 1105.

Referring back to FIG. 11, subsequent to and/or response to step/operation 1107, the example method 1100 proceeds to step/operation 1109 and ends.

Referring now to FIG. 12A and FIG. 12B, an example machine learning model based battery manufacturing method 1200 that provides various technical improvements and advantages in accordance with some embodiments of the present disclosure is illustrated. In particular, the example machine learning model based battery manufacturing method 1200 reduce the likelihood of critical errors or failures due to implementing one or more adjustments associated with the battery manufacturing process.

In the example shown in FIG. 12A, the example method 1200 starts at step/operation 1202. In some embodiments, subsequent to and/or response to step/operation 1202, the example method 1200 proceeds to step/operation 1204. At step/operation 1204, a computing device (such as, but not limited to, the example intelligent computing device described and illustrated above in connection with FIG. 1 and FIG. 2) may determine whether a predicted battery manufacturing outcome confidence-to-risk indicator satisfies the autonomous battery manufacturing adjustment threshold indicator.

As described above, each predicted battery manufacturing outcome data object is associated with a predicted battery manufacturing outcome confidence-to-risk indicator. In some embodiments, the autonomous battery manufacturing adjustment threshold indicator indicates a threshold value associated with a predicted battery manufacturing outcome confidence-to-risk indicator for autonomously adjusting one or more battery manufacturing operation parameter indicators based on a battery manufacturing adjustment data object.

For example, if the predicted battery manufacturing outcome confidence-to-risk indicator satisfies the autonomous battery manufacturing adjustment threshold indicator, the candidate battery manufacturing adjustment data object associated with the predicted battery manufacturing outcome data object can be implemented autonomously and without user supervision and/or user manual intervention. If the predicted battery manufacturing outcome confidence-to-risk indicator does not satisfy the autonomous battery manufacturing adjustment threshold indicator, the candidate battery manufacturing adjustment data object associated with the predicted battery manufacturing outcome data object cannot be implemented autonomously, and may be implemented under user supervision or may not be implemented (for example, user must manually intervene).

In some embodiments, the autonomous battery manufacturing adjustment threshold indicator may be determined based on a user input. In some embodiments, the autonomous battery manufacturing adjustment threshold indicator may be determined based on settings associated with the battery manufacturing facility.

If, at step/operation 1204, the computing device determines that the predicted battery manufacturing outcome confidence-to-risk indicator satisfies the autonomous battery manufacturing adjustment threshold indicator, the example method 1200 proceeds to step/operation 1206. At step/operation 1206, a computing device (such as, but not limited to, the example intelligent computing device described and illustrated above in connection with FIG. 1 and FIG. 2) may select a candidate battery manufacturing adjustment data object corresponding to the predicted battery manufacturing outcome data object.

For example, the computing selects a candidate battery manufacturing adjustment data object corresponding to the predicted battery manufacturing outcome data object that is associated with the predicted battery manufacturing outcome confidence-to-risk indicator satisfying the autonomous battery manufacturing adjustment threshold indicator.

Referring back to FIG. 12A, subsequent to and/or response to step/operation 1206, the example method 1200 proceeds to step/operation 1208. At step/operation 1208, a computing device (such as, but not limited to, the example intelligent computing device described and illustrated above in connection with FIG. 1 and FIG. 2) may generate the battery manufacturing adjustment data object based on the candidate battery manufacturing adjustment data object.

In some embodiments, the computing device generates the battery manufacturing adjustment data object based on the candidate battery manufacturing adjustment data object selected at step/operation 1206. For example, the battery manufacturing adjustment data object generated by the computing device may comprise one or more adjusted battery manufacturing operation parameter indicators that are the same or similar to the one or more adjusted battery manufacturing operation parameter indicators in the candidate battery manufacturing adjustment data object selected at step/operation 1206.

Referring back to FIG. 12A, subsequent to and/or response to step/operation 1208, the example method 1200 proceeds to step/operation 1210 and ends.

If, at step/operation 1204, the computing device determines that the predicted battery manufacturing outcome confidence-to-risk indicator does not satisfy the autonomous battery manufacturing adjustment threshold indicator, the example method 1200 proceeds to step/operation 1212. At step/operation 1212, a computing device (such as, but not limited to, the example intelligent computing device described and illustrated above in connection with FIG. 1 and FIG. 2) may determine whether the predicted battery manufacturing outcome confidence-to-risk indicator satisfies a supervised battery manufacturing adjustment threshold indicator.

In some embodiments, in response to determining that the predicted battery manufacturing outcome confidence-to-risk indicator does not satisfy the autonomous battery manufacturing adjustment threshold indicator, the computing device determines whether the predicted battery manufacturing outcome confidence-to-risk indicator satisfies a supervised battery manufacturing adjustment threshold indicator. As described above, the supervised battery manufacturing adjustment threshold indicator represents, indicates, and/or comprises a threshold value associated with a predicted battery manufacturing outcome confidence-to-risk indicator for adjusting one or more battery manufacturing operation parameter indicators based on a battery manufacturing adjustment data object under user supervision.

For example, if the predicted battery manufacturing outcome confidence-to-risk indicator satisfies the supervised battery manufacturing adjustment threshold indicator, the candidate battery manufacturing adjustment data object associated with the predicted battery manufacturing outcome data object can be implemented only with user supervision. If the predicted battery manufacturing outcome confidence-to-risk indicator does not satisfy the supervised battery manufacturing adjustment threshold indicator, the candidate battery manufacturing adjustment data object associated with the predicted battery manufacturing outcome data object cannot be implemented, and the user must manually intervene to address the deviation in the battery manufacturing process/operation.

If, at step/operation 1212, the computing device determines that the predicted battery manufacturing outcome confidence-to-risk indicator does not satisfy the supervised battery manufacturing adjustment threshold indicator, the example method 1200 proceeds to step/operation 1214. At step/operation 1214, a computing device (such as, but not limited to, the example intelligent computing device described and illustrated above in connection with FIG. 1 and FIG. 2) may generate a battery manufacturing manual adjustment request.

For example, in response to determining that the predicted battery manufacturing outcome confidence-to-risk indicator does not satisfy the supervised battery manufacturing adjustment threshold indicator, the computing device generates a battery manufacturing manual adjustment request. In this example, the battery manufacturing manual adjustment request indicates a request to a user to manually intervene and adjust battery manufacturing operation parameter indicators, without utilizing the battery manufacturing adjustment data object.

Referring back to FIG. 12A, subsequent to and/or response to step/operation 1214, the example method 1200 proceeds to step/operation 1210 and ends.

If, at step/operation 1204, the computing device determines that the predicted battery manufacturing outcome confidence-to-risk indicator satisfies the supervised battery manufacturing adjustment threshold indicator, the example method 1200 proceeds to block A, which connects FIG. 12A to FIG. 12B. Referring now to FIG. 12B, subsequent to and/or response to block A, the example method 1200 proceeds to step/operation 1216. At step/operation 1216, a computing device (such as, but not limited to, the example intelligent computing device described and illustrated above in connection with FIG. 1 and FIG. 2) may select a candidate battery manufacturing adjustment data object corresponding to the predicted battery manufacturing outcome data object.

In some embodiments, the computing device selects the candidate battery manufacturing adjustment data object corresponding to the predicted battery manufacturing outcome data object that is associated with the predicted battery manufacturing outcome confidence-to-risk indicator satisfying the supervised battery manufacturing adjustment threshold indicator.

Referring back to FIG. 12B, subsequent to and/or response to step/operation 1216, the example method 1200 proceeds to step/operation 1218. At step/operation 1218, a computing device (such as, but not limited to, the example intelligent computing device described and illustrated above in connection with FIG. 1 and FIG. 2) may generate the battery manufacturing adjustment data object based at least in part on the candidate battery manufacturing adjustment data object.

In some embodiments, the computing device generates the battery manufacturing adjustment data object based at least in part on the candidate battery manufacturing adjustment data object selected at step/operation 1216. For example, the battery manufacturing adjustment data object may comprise one or more adjusted battery manufacturing operation parameter indicators that are similar or the same as the adjusted battery manufacturing operation parameter indicators described in the candidate battery manufacturing adjustment data object.

Referring back to FIG. 12B, subsequent to and/or response to step/operation 1218, the example method 1200 proceeds to step/operation 1220. At step/operation 1220, a computing device (such as, but not limited to, the example intelligent computing device described and illustrated above in connection with FIG. 1 and FIG. 2) may generate a battery manufacturing supervision request associated with the battery manufacturing adjustment data object.

In some embodiments, the computing device generates the battery manufacturing supervision request associated with the battery manufacturing adjustment data object, and transmits the battery manufacturing supervision request and the battery manufacturing adjustment data object to a user device. In some embodiments, the battery manufacturing supervision request indicates a request to the user to review the adjustments described in the battery manufacturing adjustment data object. If the user provides approval indications on the adjustments, the computing device may implement the adjustments described in the battery manufacturing adjustment data object. If the user does not prove approval indications on the adjustments, the computing device may not implement the adjustments described in the battery manufacturing adjustment data object.

Referring back to FIG. 12B, subsequent to and/or response to step/operation 1220, the example method 1200 proceeds to step/operation 1222 and ends.

Referring now to FIG. 13, an example machine learning model based battery manufacturing method 1300 that provides various technical improvements and advantages in accordance with some embodiments of the present disclosure is provided.

In some embodiments, a computing device (such as, but not limited to, the autonomous agent module of the example intelligent computing device described and illustrated above in connection with FIG. 1 and FIG. 2) may contextualize and analyze battery manufacturing operation parameter indicators associated with a battery manufacturing facility at step/operation 1301 and generates a battery manufacturing deviation event data object representing a new deviation event at step/operation 1303.

In some embodiments, a computing device (such as, but not limited to, the autonomous agent module of the example intelligent computing device described and illustrated above in connection with FIG. 1 and FIG. 2) may determine that the battery manufacturing deviation event data object is similar to one or more historical battery manufacturing deviation event data objects at step/operation 1305. In such embodiments, a computing device (such as, but not limited to, the simulation engine module of the example intelligent computing device described and illustrated above in connection with FIG. 1 and FIG. 2) may, at step/operation 1307, simulate one or more adjusted battery manufacturing operation parameter indicators based on one or more historical battery manufacturing adjustment data objects that are associated with the one or more similar historical battery manufacturing deviation event data objects.

In some embodiments, a computing device (such as, but not limited to, the autonomous agent module of the example intelligent computing device described and illustrated above in connection with FIG. 1 and FIG. 2) may determine that the battery manufacturing deviation event data object is not similar to any historical battery manufacturing deviation event data objects at step/operation 1309. In such embodiments, a computing device (such as, but not limited to, the simulation engine module of the example intelligent computing device described and illustrated above in connection with FIG. 1 and FIG. 2) may, at step/operation 1311, reevaluate options by generating one or more candidate adjusted battery manufacturing operation parameter indicators, and then simulate one or more candidate adjusted battery manufacturing operation parameter indicators.

In some embodiments, a computing device (such as, but not limited to, the analytics engine module of the example intelligent computing device described and illustrated above in connection with FIG. 1 and FIG. 2) may analyze the simulation outcomes from the simulation engine module, and determine whether the simulated outcomes satisfies the confidence to risk thresholds.

For example, if the computing device determines that the confidence to risk ratio of a simulated outcome is high at step/operation 1313, the computing device causes the adjusted battery manufacturing operation parameter indicator to be deployed at step/operation 1319.

As another example, if the computing device determines that the confidence to risk ratio of a simulated outcome is low at step/operation 1315, the computing device requests user's assisted actions at step/operation 1321 and/or the operator's attention at step/operation 1323.

As another example, if the computing device determines that the simulated outcome is not feasible at step/operation 1317, the computing device requests the operator's attention at step/operation 1325 to manually intervene.

At step/operation 1327, based on the actions at step/operation 1319, step/operation 1321, step/operation 1323, and step/operation 1325, a computing device (such as, but not limited to, the example intelligent computing device described and illustrated above in connection with FIG. 1 and FIG. 2) may update the knowledge repository (similar to the skill/knowledge/rule data repository 519 described above in connection with FIG. 5).

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

1. An apparatus comprising at least one processor and at least one non-transitory memory comprising a computer program code, the at least one non-transitory memory and the computer program code configured to, with the at least one processor, cause the apparatus to:
receive a battery manufacturing operation parameter indicator, wherein the battery manufacturing operation parameter indicator is associated with a battery manufacturing batch indicator and a battery manufacturing operation indicator;
determine whether the battery manufacturing operation parameter indicator satisfies a battery manufacturing parameter threshold indicator, wherein the battery manufacturing parameter threshold indicator is associated with the battery manufacturing operation indicator;
in response to determining that the battery manufacturing operation parameter indicator does not satisfy the battery manufacturing parameter threshold indicator:
generate a battery manufacturing deviation event data object, wherein the battery manufacturing deviation event data object comprises the battery manufacturing operation parameter indicator and a plurality of additional battery manufacturing operation parameter indicators that is associated with the battery manufacturing batch indicator, and
generate a battery manufacturing adjustment data object based at least in part on inputting the battery manufacturing deviation event data object to one or more machine learning models.

2. The apparatus of claim 1, wherein the plurality of additional battery manufacturing operation parameter indicators is associated with a plurality of additional battery manufacturing operation indicators, wherein the plurality of additional battery manufacturing operation indicators is different from the battery manufacturing operation indicator.

3. The apparatus of claim 2, wherein the battery manufacturing adjustment data object comprises an adjusted battery manufacturing operation parameter indicator.

4. The apparatus of claim 1, wherein the one or more machine learning models comprise a deviation event similarity determination machine learning model, wherein the at least one non-transitory memory and the computer program code are configured to, with the at least one processor, cause the apparatus to:
receive, from a battery manufacturing deviation event repository, a plurality of historical battery manufacturing deviation event data objects;
input the battery manufacturing deviation event data object and the plurality of historical battery manufacturing deviation event data objects to the deviation event similarity determination machine learning model; and
receive, from the deviation event similarity determination machine learning model, a plurality of deviation event similarity indicators.

5. The apparatus of claim 4, wherein each of the plurality of deviation event similarity indicators indicates a corresponding deviation event similarity level between the battery manufacturing deviation event data object and one of the plurality of historical battery manufacturing deviation event data objects.

6. The apparatus of claim 4, wherein a deviation event similarity indicator is associated with the battery manufacturing deviation event data object and a historical battery manufacturing deviation event data object from the plurality of historical battery manufacturing deviation event data objects, wherein the at least one non-transitory memory and the computer program code are configured to, with the at least one processor, cause the apparatus to:
in response to determining that the deviation event similarity indicator satisfies a deviation event similarity threshold indicator:
receive, from the battery manufacturing deviation event repository, a historical battery manufacturing adjustment data object corresponding to the historical battery manufacturing deviation event data object; and
generate the battery manufacturing adjustment data object based at least in part on the historical battery manufacturing adjustment data object.

7. The apparatus of claim 4, wherein the one or more machine learning models comprise a deviation event classification estimation machine learning model, wherein the at least one non-transitory memory and the computer program code are configured to, with the at least one processor, cause the apparatus to:
in response to determining that the plurality of deviation event similarity indicators does not satisfy a deviation event similarity threshold indicator:
input the battery manufacturing deviation event data object to the deviation event classification estimation machine learning model; and
receive, from the deviation event classification estimation machine learning model, an estimated deviation event classification indicator associated with the battery manufacturing deviation event data object and a plurality of candidate battery manufacturing adjustment data objects.

8. The apparatus of claim 7, wherein each of the plurality of candidate battery manufacturing adjustment data objects comprises at least one candidate adjusted battery manufacturing operation parameter indicator.

9. The apparatus of claim 7, wherein the one or more machine learning models comprise a battery manufacturing outcome prediction machine learning model, wherein the at least one non-transitory memory and the computer program code are configured to, with the at least one processor, cause the apparatus to:
input the plurality of candidate battery manufacturing adjustment data objects to the battery manufacturing outcome prediction machine learning model;
receive, from the battery manufacturing outcome prediction machine learning model, a plurality of predicted battery manufacturing outcome data objects associated with the plurality of candidate battery manufacturing adjustment data objects; and
generate the battery manufacturing adjustment data object based at least in part on the plurality of candidate battery manufacturing adjustment data objects and the plurality of predicted battery manufacturing outcome data objects.

10. The apparatus of claim 9, wherein the plurality of predicted battery manufacturing outcome data objects is associated with a plurality of predicted battery manufacturing outcome confidence-to-risk indicators.

11. A computer-implemented method, wherein the computer-implemented method comprises:
receiving a battery manufacturing operation parameter indicator, wherein the battery manufacturing operation parameter indicator is associated with a battery manufacturing batch indicator and a battery manufacturing operation indicator;
determining whether the battery manufacturing operation parameter indicator satisfies a battery manufacturing parameter threshold indicator, wherein the battery manufacturing parameter threshold indicator is associated with the battery manufacturing operation indicator;
in response to determining that the battery manufacturing operation parameter indicator does not satisfy the battery manufacturing parameter threshold indicator:
generating a battery manufacturing deviation event data object, wherein the battery manufacturing deviation event data object comprises the battery manufacturing operation parameter indicator and a plurality of additional battery manufacturing operation parameter indicators that is associated with the battery manufacturing batch indicator; and
generating a battery manufacturing adjustment data object based at least in part on inputting the battery manufacturing deviation event data object to one or more machine learning models.

12. The method of claim 11, wherein the plurality of additional battery manufacturing operation parameter indicators is associated with a plurality of additional battery manufacturing operation indicators, wherein the plurality of additional battery manufacturing operation indicators is different from the battery manufacturing operation indicator.

13. The method of claim 12, wherein the battery manufacturing adjustment data object comprises an adjusted battery manufacturing operation parameter indicator.

14. The method of claim 11, wherein the one or more machine learning models comprise a deviation event similarity determination machine learning model, and wherein the method further comprises:
receiving, from a battery manufacturing deviation event repository, a plurality of historical battery manufacturing deviation event data objects;
inputting the battery manufacturing deviation event data object and the plurality of historical battery manufacturing deviation event data objects to the deviation event similarity determination machine learning model; and
receiving, from the deviation event similarity determination machine learning model, a plurality of deviation event similarity indicators.

15. The method of claim 14, wherein each of the plurality of deviation event similarity indicators indicates a corresponding deviation event similarity level between the battery manufacturing deviation event data object and one of the plurality of historical battery manufacturing deviation event data objects.

16. The method of claim 14, wherein a deviation event similarity indicator is associated with the battery manufacturing deviation event data object and a historical battery manufacturing deviation event data object from the plurality of historical battery manufacturing deviation event data objects, wherein the method further comprises:
in response to determining that the deviation event similarity indicator satisfies a deviation event similarity threshold indicator:
receiving, from the battery manufacturing deviation event repository, a historical battery manufacturing adjustment data object corresponding to the historical battery manufacturing deviation event data object; and
generating the battery manufacturing adjustment data object based at least in part on the historical battery manufacturing adjustment data object.

17. The method of claim 14, wherein the one or more machine learning models comprise a deviation event classification estimation machine learning model, wherein the method further comprises:
in response to determining that the plurality of deviation event similarity indicators does not satisfy a deviation event similarity threshold indicator:
inputting the battery manufacturing deviation event data object to the deviation event classification estimation machine learning model; and
receiving, from the deviation event classification estimation machine learning model, an estimated deviation event classification indicator associated with the battery manufacturing deviation event data object and a plurality of candidate battery manufacturing adjustment data objects.

18. The method of claim 17, wherein each of the plurality of candidate battery manufacturing adjustment data objects comprises at least one candidate adjusted battery manufacturing operation parameter indicator.

19. The method of claim 17, wherein the one or more machine learning models comprise a battery manufacturing outcome prediction machine learning model, wherein the method further comprises:
inputting the plurality of candidate battery manufacturing adjustment data objects to the battery manufacturing outcome prediction machine learning model;
receiving, from the battery manufacturing outcome prediction machine learning model, a plurality of predicted battery manufacturing outcome data objects associated with the plurality of candidate battery manufacturing adjustment data objects; and
generating the battery manufacturing adjustment data object based at least in part on the plurality of candidate battery manufacturing adjustment data objects and the plurality of predicted battery manufacturing outcome data objects.

20. The method of claim 19, wherein the plurality of predicted battery manufacturing outcome data objects is associated with a plurality of predicted battery manufacturing outcome confidence-to-risk indicators.
